(19) United States
(12) Patent Application Publication
(10) Pub. No.: US 2007/0075959 A1
(43) Pub. Date: Apr. 5, 2007

(54) DISPLAY DEVICE

(75) Inventor: Youichi TOBITA, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/533,196

(22) Filed: Sep. 19, 2006

(30) Foreign Application Priority Data
Oct. 4, 2005 (JP) 2005-290749
May 19, 2006 (JP) 2006-139957

(51) Int. Cl. G09G 3/36

(52) U.S. Cl. 345/98

(57) ABSTRACT

A display device includes a gate driver for driving pixels (PX), a drive control circuit for outputting a predetermined control signal to the gate driver, and a frequency division circuit. The pixels, the gate driver, and the frequency division circuit are formed using amorphous silicon thin film transistors (a-Si TFTs) formed on an insulating substrate. The control signal output from the drive control circuit includes a start signal for a start of a frame period of an image signal, and the frequency division circuit generates a frequency division signal whose period corresponds to a frequency which is obtained by dividing a frequency of the start signal.

### BACKGROUND OF THE INVENTION

1. Field of the Invention

The present invention relates to a display device including a gate driver which includes a thin film transistor (TFT).

2. Description of the Background Art

A display device such as a liquid crystal display or an organic electroluminescent (EL) display includes pixels arranged in a matrix on an insulating substrate such as a glass substrate, gate lines (scanning lines) respectively provided for rows of the pixels (pixel lines), and a gate driver for selecting and driving the gate lines one by one. A gate driver can be formed using a shift register. In this regard, it is desirable that a shift register used for forming a gate driver includes only field effect transistors of the same conductivity type, for purposes of simplifying manufacturing processes. Hence, various types of shift registers each of which includes only n-channel or p-channel field effect transistors have been suggested, along with various types of display devices including the foregoing shift registers.

On the other hand, a display device which employs an amorphous silicon thin film transistor (a-Si TFT) as a field effect transistor forming a gate driver has been widely applied to a screen of a laptop personal computer or a large-screen display apparatus, for example, because of ease in increasing an area and high productivity thereof.

With respect to an a-Si TFT, it has been known that a phenomenon of significant shift in a threshold voltage occurs when a gate electrode is continually (like a direct current) biased. That phenomenon probably causes malfunction of a gate driver formed using an a-Si TFT, to present a problem. Also, it has been found that a similar problem arises in not only an a-Si TFT but also an organic TFT.

One solution to the foregoing problem is to provide a parallel arrangement of two a-Si TFTs for pulling down an output at an output stage of a gate driver and make the two a-Si TFTs alternately operative and inoperative from frame to frame. In this manner, a gate electrode of each of the a-Si TFTs is prevented from being continually biased in a gate driver circuit (refer to Soon Young Yoon et al., “Highly Stable Integrated Gate Driver Circuit using a-Si TFT with Dual Pull-down Structure”, SID 05 DIGEST, pp. 348, for example, which will be hereinafter referred to as “Soon Young Yoon et al.”).

However, an LSI of a general-purpose drive control circuit which has conventionally been used does not output a control signal (switching signal) for switching a state of each of the foregoing two a-Si TFTs for pulling down an output, between an operative state and an inoperative state from frame to frame. Thus, there is a need of additionally providing a circuit for generating a switching signal in a drive control circuit, in order to apply the techniques taught in Soon Young Yoon et al. However, when such a circuit as mentioned above is additionally provided in a drive control circuit, the drive control circuit should have specialized specifications which are different from those of the conventional drive control circuit. This increases manufacturing costs associated with the drive control circuit, and thus increases manufacturing costs associated with a display device.

### SUMMARY OF THE INVENTION

It is an object of the present invention to provide a display device which is able to prevent variation in a threshold voltage of a TFT of a gate driver with the use of a general-purpose drive control circuit.

A display device according to the present invention includes; an insulating substrate; a plurality of pixels arranged on the insulating substrate; a gate driver for driving the plurality of pixels; a drive control circuit for outputting a predetermined control signal to the gate driver; and a frequency division circuit for dividing a frequency of a signal. The plurality of pixels, the gate driver, and the frequency division circuit are formed using thin film transistors (TFTs) formed on the insulating substrate. The control signal output from the drive control circuit includes a start signal for a start of a frame period of an image signal. The frequency division circuit generates a frequency division signal whose period corresponds to a frequency which is obtained by dividing a frequency of the start signal.

It is possible to switch between two output pull-down TFTs included in the gate driver from frame to frame based on the frequency division circuit. The frequency division signal is obtained by dividing a frequency of each of two start signals output from a general-purpose drive control circuit. Thus, a gate driver of a type in which two output pull-down TFTs are switched from frame to frame can be actuated by using a general-purpose drive control circuit. Accordingly, it is possible to prevent malfunction which is likely to occur due to variation in a threshold voltage of a TFT of the gate driver while suppressing an increase in costs associated with the display device. Also, the frequency division circuit is formed using the TFTs formed on the same substrate in which the TFTs used for forming the pixels and the gate driver are formed. Hence, complication of manufacturing processes which may be caused due to inclusion of the frequency division circuit in the display device can be avoided.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram roughly illustrating a conventional display device.

FIG. 2 is a circuit diagram illustrating an example of arrangement of pixels in a display device.

FIG. 3 is a timing chart showing operations of conventional gate drivers (odd-number gate driver and even-number gate driver).

FIG. 4 is a block diagram roughly illustrating a structure of a display device according to the present invention.

FIG. 5 is a circuit diagram illustrating a basic configuration of a frequency division circuit according to the present invention.

FIG. 6 is a timing chart showing basic operations of the frequency division circuit according to the present invention.

FIG. 7 is a circuit diagram of a frequency division circuit according to a first preferred embodiment.

FIGS. 8 and 9 are timing charts showing operations of the frequency division circuit according to the first preferred embodiment.

FIG. 10 is a block diagram illustrating a modification of the display device according to the present invention.

FIG. 11 is a timing chart showing operations in the modification of the display device according to the present invention.

FIG. 12 illustrates a circuit configuration of a frequency division circuit according to a second preferred embodiment.

FIG. 13 is a timing chart showing operations of the frequency division circuit according to the second preferred embodiment.

FIG. 14 illustrates a circuit configuration of a frequency division circuit according to a third preferred embodiment.

FIG. 15 illustrates a circuit configuration of a frequency division circuit according to a fourth preferred embodiment.

FIG. 16 is a circuit diagram of a conventional unit shift register.

FIG. 17 illustrates a structure of a conventional gate driver.

FIG. 18 is a timing chart showing operations of the conventional gate driver.

FIG. 19 is a circuit diagram of a unit shift register according to a fifth preferred embodiment.

FIG. 20 is a block diagram roughly illustrating a structure of a display device according to a sixth preferred embodiment.

FIG. 21 is a timing chart showing operations of a frequency division circuit according to the sixth preferred embodiment.

FIG. 22 illustrates a circuit configuration of a frequency division circuit according to a seventh preferred embodiment.

FIG. 23 is a timing chart showing operations of the frequency division circuit according to the seventh preferred embodiment.

FIG. 24 is a block diagram roughly illustrating a structure of a display device according to an eighth preferred embodiment.

FIG. 25 is a timing chart showing operations of a frequency division circuit according to the eighth preferred embodiment.

### DESCRIPTION OF THE PREFERRED EMBODIMENTS

Below, preferred embodiments of the present invention will be described with reference to accompanying drawings. It is noted that the same reference numerals are used for denoting elements having the same or corresponding functions in the drawings in order to avoid verbosity due to duplicated descriptions.

### First Preferred Embodiment

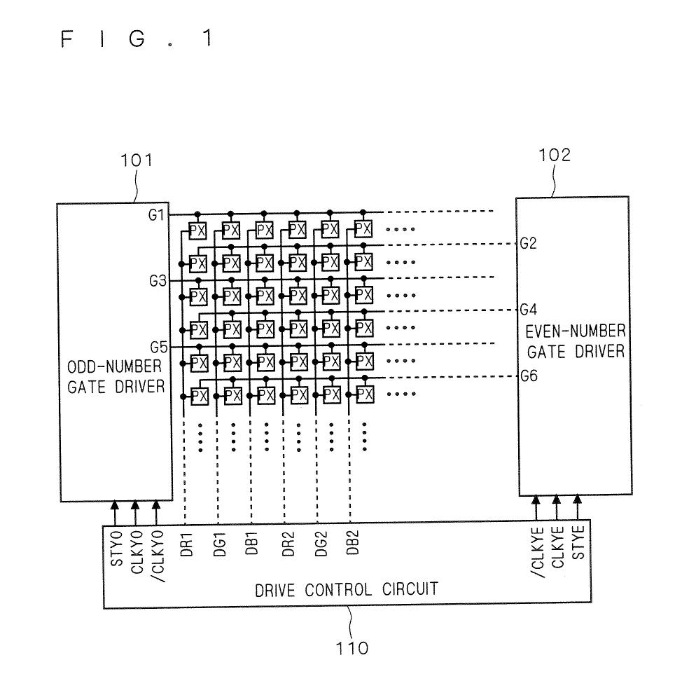

Specific preferred embodiments of the present invention will be described as follows. However, as a preliminary, a conventional general-purpose drive control circuit and a conventional general-purpose gate driver will be described for the sake of easier understanding of the present invention. FIG. 1 is a block diagram illustrating an example of a structure of a conventional display device.

In the display device illustrated in FIG. 1, pixels PX formed using a-Si TFTs which are formed on an insulating substrate such as a glass substrate are arranged in a matrix. As an example of the pixels PX, a pixel formed using a liquid crystal element and a pixel formed using an electroluminescent element such as an organic electroluminescent (EL) element are cited, for example.

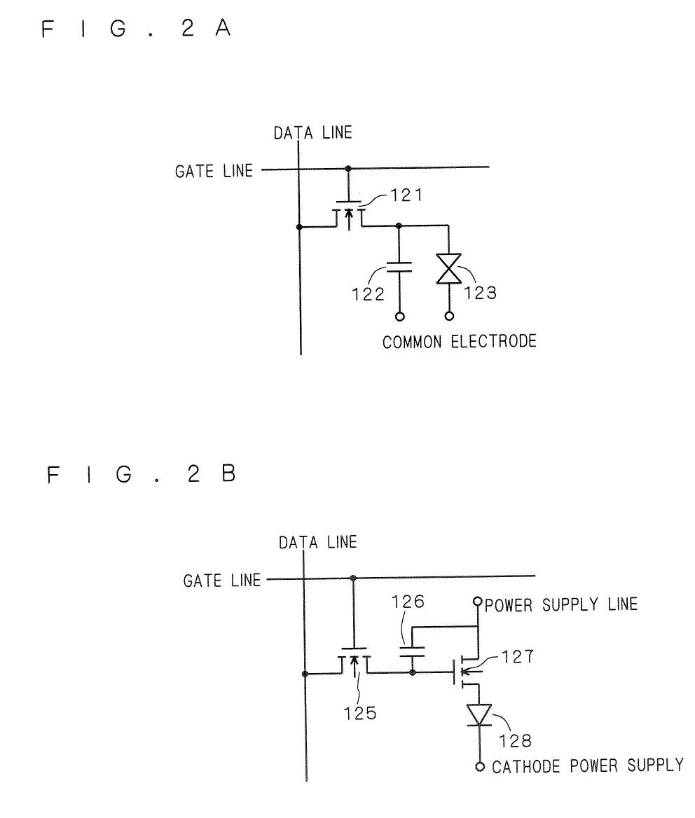

FIG. 2A illustrates an example of a structure of a liquid crystal pixel formed using a-Si TFTs. A gate line is connected with a gate of an active element 121 (a-Si TFT) and a data line is connected with a drain of the active element 121. Also, a source of the active element 121 is connected with one end of a storage capacitor 122 and one end of a liquid crystal element 123. The other end of the storage capacitor 122 and the other end of the liquid crystal element 123 are connected to a common electrode. Accordingly, when the gate line is active (at High (H) level), the active element 121 is turned on and data (potential) of the data line at that time is stored in the storage capacitor 122. Then, the orientation of a liquid crystal contained in the liquid crystal element 123 changes depending on the data stored in the storage capacitor 122, to cause a change in brightness for display of the corresponding pixel.

On the other hand, FIG. 2B illustrates an example of a structure of an organic EL pixel formed using a-Si TFTs. A gate line is connected with a gate of an active element 125 (a-Si TFT) and a data line is connected with a drain of the active element 125. A source of the active element 125 is connected with one end of a storage capacitor 126 and a gate of a drive TFT (a-Si TFT) 127. A drain of the drive TFT 127 is connected with one end of an EL element 128. The other end of the storage capacitor 126 and a source of the drive TFT 127 are connected to a preset power supply line, and the other end of the EL element 128 is connected to a cathode power supply. Accordingly, when the gate line is active (at H level), the active element 125 is turned on and data (potential) of the data line at that time is stored in the storage capacitor 126. Then, the drive TFT 127 is turned on or off depending on the data stored in the storage capacitor 126. When the drive TFT 127 is turned on, a current flows through the EL element 128, so that the corresponding pixel emits light.

Each of the pixels PX is driven by gate drivers 101, 102 and a drive control circuit 110 which will be described as follows. In the conventional example illustrated in FIG. 1, two gate drivers 101 and 102 which are formed using a-Si TFTs formed on the same insulating substrate on which the pixels PX are formed are provided on opposite sides of the matrix of the pixels PX (pixel matrix). The gate driver 101 provided on the left-hand side of the pixel matrix functions to drive gate lines G1, G3, G5, . . . which are associated with odd-numbered pixel lines, and the gate driver 102 provided on the right-hand side of the pixel matrix functions to drive gate lines G2, G4, G6, . . . which are associated with even-numbered pixel lines. The foregoing manner of driving can cope with a situation in which a pitch in a scanning direction of the pixels PX is small, to allow for an increase in density of the pixels PX, in other words, an increase in resolution of a screen. In the following description, the gate driver 101 will be referred to as an “odd-number gate driver 101” and the gate driver 102 will be referred to as an “even-number gate driver 102”.

The drive control circuit 110 is a general-purpose LSI formed using single crystal silicon. The drive control circuit 110 includes a source driver circuit for outputting display data which is to be written into the pixels PX to a data line (DR1, DG1, DB1, DR2, DG2, DB2, . . . ), a generation circuit for generating a drive control signal (a start signal and a clock signal) required for driving the gate drivers 101 and 102, a power supply circuit for generating a power supply voltage, and the like.

The drive control signal output from the drive control circuit 110 includes a start pulse for a start of one frame period of an image signal and a clock signal which determines operation timings of the gate drivers 101 and 102, which are output to the gate drivers 101 and 102. In a case where the pixel matrix is driven using the two gate drivers 101 and 102, the drive control circuit 110 outputs a start signal STYO for starting scanning of the odd-numbered gate lines, a clock signal CLKYO for determining operation timings of the odd-number gate driver 101, and a clock signal /CLKYO which is of an opposite phase to the clock signal CLKYO, to the odd-number gate driver 101.

Also, the drive control circuit 110 outputs a start signal STYE for starting scanning of the even-numbered gate lines, a clock signal CLKYE for determining operation timings of the even-number gate driver 102, and a clock signal /CLKYE which is of an opposite phase to the clock signal CLKYE, to the even-number gate driver 102.

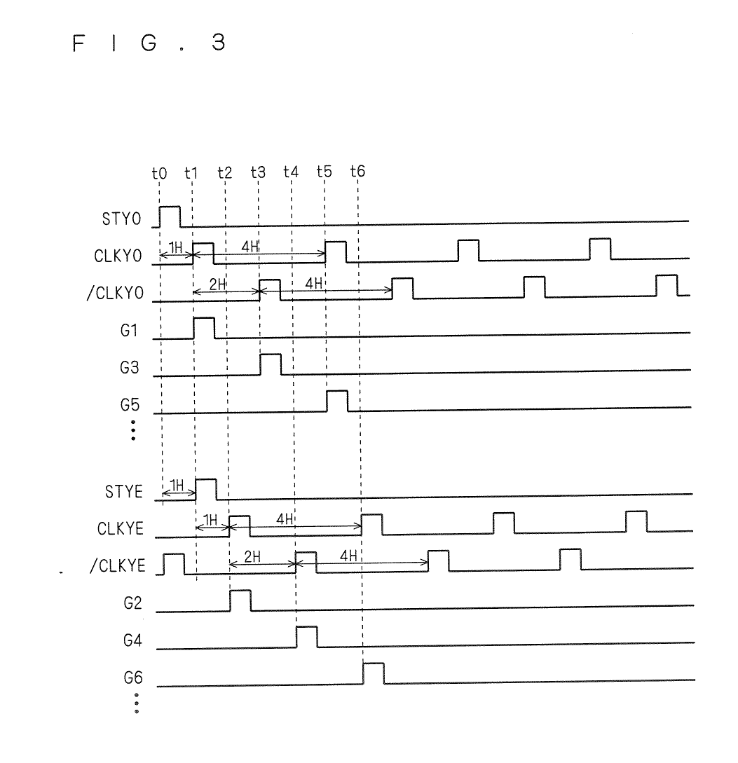

Waveforms of the above-mentioned signals included in the drive control signal are shown in FIG. 3. As shown in FIG. 3, each of the clock signal CLKYO and the clock signal /CLKYO is a pulse signal whose period is equal to four horizontal periods (4 H) of the display device (one horizontal period is a period required for scanning one horizontal line), and the clock signals CLKYO and /CLKYO are out of phase with each other by two horizontal periods (2 H). Likewise, each of the clock signal CLKYE and the clock signal /CLKYE is a pulse signal whose period is equal to four horizontal periods (4 H) of the display device, and the clock signals CLKYE and /CLKYE are out of phase with each other by two horizontal periods (2 H). Further, the clock signal CLKYO and the clock signal CLKYE are out of phase with each other by one horizontal period (1 H). Thus, the four clock signals CLKYO, CLKYE, /CLKYO, and /CLKYE forms a four-phase clock signal having four phases which are displaced one horizontal period with respect to one another.

The drive control circuit 110 outputs the start signal STYO to the odd-number gate driver 101 at a time t0 at which one frame period starts. Subsequently, the clock signal CLKYO is input to the odd-number gate driver 101 at a time t1 which lags one horizontal period (1 H) behind a time t0, and further, the clock signal /CLKYO is input to the odd-number gate driver 101 at a time t3 which lags two horizontal periods (2 H) behind a time t1.

A shift register forming the odd-number gate driver 101 shifts the start signal STYO through the odd-numbered gate lines in order, from the gate line G1 to the gate line G3 to the gate line G5, . . . , in synchronization with the clock signals CLKYO and /CLKYO. As a result, the odd-numbered gate lines G1, G3, G5, . . . sequentially become active (at H level) every two horizontal periods, in synchronization with the clock signals CLKYO and /CLKYO, as shown in FIG. 3.

On the other hand, the start signal STYE is input to the even-number gate driver 102 at a time t1 which lags one horizontal period (1 H) behind a time t0. Subsequently, the clock signal CLKYE is input to the even-number gate driver 102 at a time t2 which lags one horizontal period (1 H) behind a time t1, and further, the clock signal /CLKYE is input to the even-number gate driver 102 at a time t4 which lags two horizontal periods (2 H) behind a time t2.

A shift register forming the even-number gate driver 102 shifts the start signal STYE through the even-numbered gate lines in order, from the gate line G2 to the gate line G4 to the gate line G6, . . . , in synchronization with the clock signals CLKYE and /CLKYE. As a result, the even-numbered gate lines G2, G4, G6, . . . sequentially become active (at H level) every two horizontal periods, in synchronization with the clock signals CLKYE and /CLKYE, as shown in FIG. 3.

The clock signals CLKYO and /CLKYO input to the odd-number gate driver 101 and the clock signals CLKYE and /CLKYE input to the even-number gate driver 102 are respectively out of phase with each other by one horizontal period, so that the odd-numbered gate lines and the even-numbered gate lines become active by turns.

As a consequence of the above-described operations, all the gate lines G1, G2, G3, G4, . . . are selected in order every horizontal period, as shown in FIG. 3.

Additionally, if the density of the pixels PX is low, only a single gate driver is provided on one side of the pixel matrix, and functions to drive the pixel matrix in some cases, though illustration therefor is omitted. In those cases, as there is no need of distinguishing the even-numbered gate lines and the odd-numbered gate lines from each other, the drive control circuit operates to output a two-phase clock signals and one start signal every frame period so that all the gate lines are sequentially selected by one gate driver in accordance with the foregoing signals.

Moreover, various types of general-purpose drive control circuits (LSI) includes a type that is configured to be able to output both of a drive control signal adapted to a case where one gate driver is provided and a drive control signal adapted to a case where two gate drivers are provided, to cope with the both cases. Specifically, such type of a general-purpose drive control circuit as mentioned above is configured such that both of a set of a four-phase clock signal and a two-phase start signal for driving two gate drivers and a set of a two-phase clock signal and a one-phase start signal for driving one gate driver can be output.

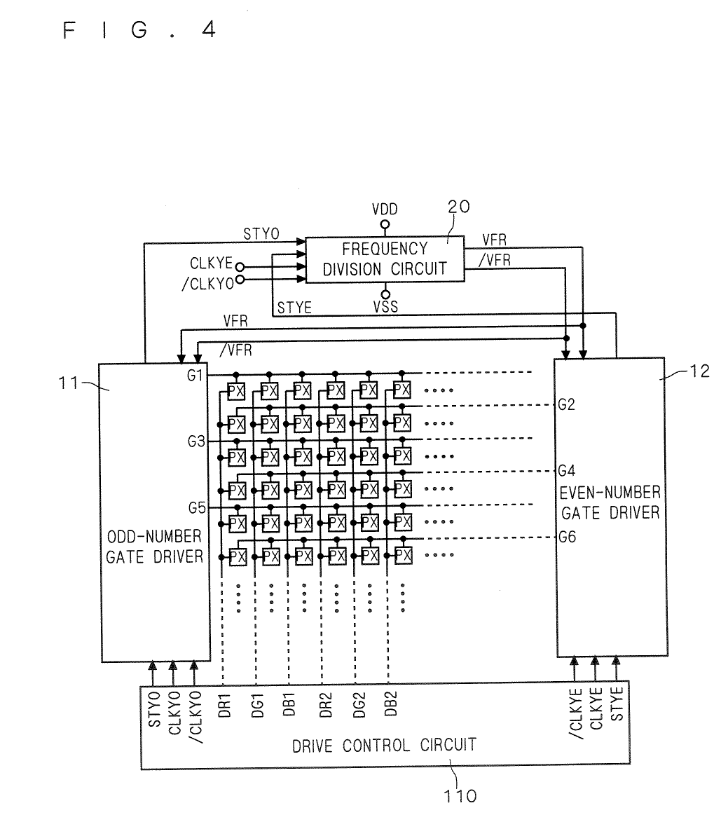

Now, a display device according to the present invention will be described. FIG. 4 is a block diagram roughly illustrating a structure of the display device according to the present invention.

According to a first preferred embodiment, pixels PX formed using a-Si TFTs which are formed on an insulating substrate are arranged in a matrix, and two gate drivers 11 and 12 which are formed using a-Si TFTs formed on the same insulating substrate on which the matrix of the pixels PX (pixel matrix) is formed are provided on opposite sides of the pixel matrix. The odd-number gate driver 11 provided on the left-hand side of the pixel matrix functions to drive gate lines G1, G3, G5, . . . which are associated with the odd-numbered pixel lines, and the even-number gate driver 12 provided on the right-hand side of the pixel matrix functions to drive gate lines G2, G4, G6, . . . which are associated with the even-numbered pixel lines.

Basic operations of the gate drivers 11 and 12 are identical to those of the conventional gate drivers 101 and 102 which are illustrated in FIG. 1. However, according to the first preferred embodiment, a method in which two a-Si TFTs for pulling down an output (“output pull-down a-Si TFT”) are switched from frame to frame in order to prevent a shift in a threshold voltage of an a-Si TFT (as taught in Soon Young Yoon et al., for example) is applied to the gate drivers 11 and 12. Thus, a control signal (switching signal) for switching between two output pull-down a-Si TFTs is required in order to allow the gate drivers 11 and 12 to properly operate.

Also, the drive control circuit 110 illustrated in FIG. 4 is a general-purpose LSI formed using single crystal silicon, like the drive control circuit illustrated in FIG. 1. More specifically, the drive control circuit 110 outputs the start signal STYO and the clock signals CLKYO and /CLKYO which have been described above, to the odd-number gate driver 101 as the drive control signal. Further, the drive control circuit 110 outputs the start signal STYE and the clock signals CLKYE and /CLKYE which have been described above, to the even-number gate driver 12 as the drive control signal.

The display device according to the first preferred embodiment includes a frequency division circuit 20 which is formed using a-Si TFTs formed on the insulating substrate and functions to divide a frequency of a signal. The frequency division circuit 20 receives the two start signals STYO and STYE and the two clock signals CLKYE and /CLKYO as illustrated in FIG. 4. The frequency division circuit 20 is driven by the above-mentioned four signals, to output a frequency division signal VFR whose period is twice the period of the start signal STYO or STYE (in other words, whose frequency is equal to a half of the frequency of the start signal STYO or STYE), and a frequency division signal /VFR which is of an opposite phase to the frequency division signal VFR.

The start signals STYO and STYE are associated with a starting time of each of frame periods of an image signal. Hence, each of the frequency division signals VFR and /VFR which are obtained by doubling the period of the start signal STYO or STYE is a signal which is inverted every frame period of the image signal. Both the frequency division signals VFR and /VFR are input to the gate drivers 11 and 12, in which the frequency division signals VFR and /VFR are used as switching signals for switching between the two output pull-down a-Si TFTs.

According to the first preferred embodiment, a switching signal for switching between the two output pull-down a-Si TFTs of each of the gate drivers 11 and 12 can be obtained with the use of the general-purpose drive control circuit 110 which has been conventionally used. Thus, an effect in which variation in a threshold voltage of an a-Si TFT of each of the gate drivers 11 and 12 can be suppressed with the use of a general-purpose drive control circuit to thereby prevent malfunction, can be produced.

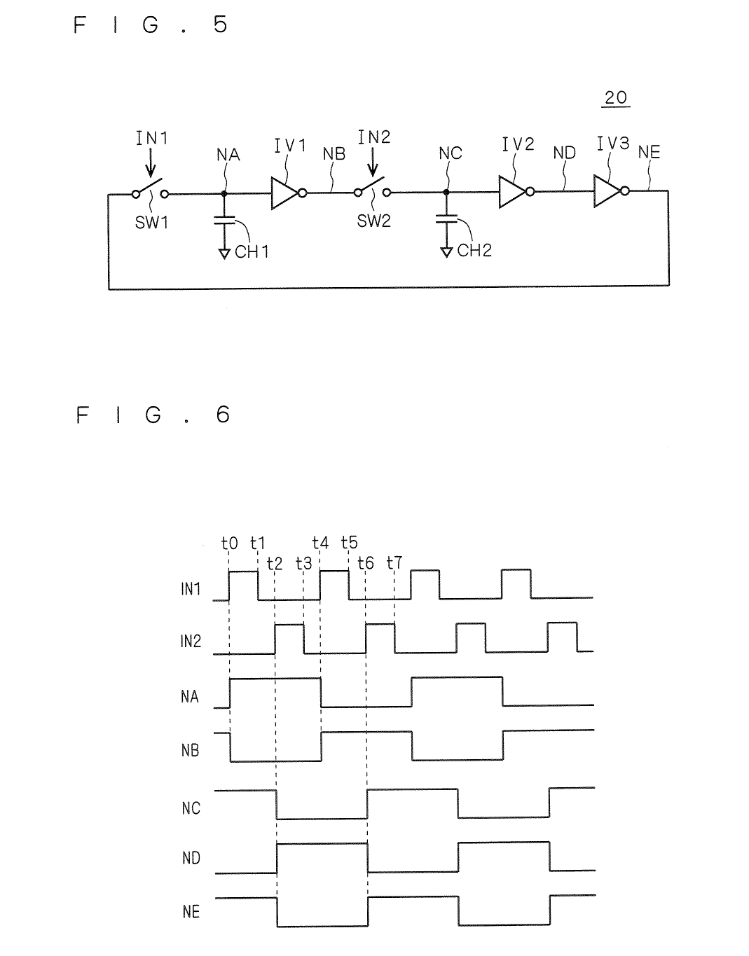

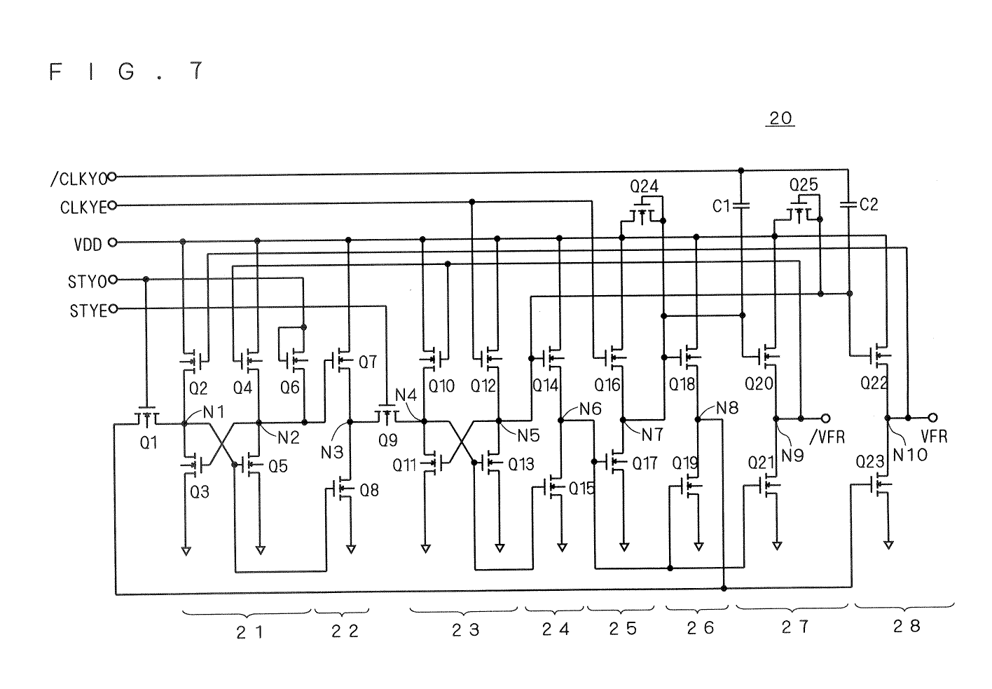

Next, the frequency division circuit 20 according to the first preferred embodiment will be described. FIG. 5 is a circuit diagram illustrating a basic configuration of the frequency division circuit 20, and FIG. 6 is a timing chart showing operations of the frequency division circuit 20. First, the principle of operations of the frequency division circuit 20 will be described with reference to FIGS. 5 and 6.

As illustrated in FIG. 5, the frequency division circuit 20 includes switches SW1 and SW2, inverters IV1, IV2, and IV3 (first, second and third inverters), and storage capacitors CH1 and CH2 serving as holding circuits. The storage capacitor CH1 is connected to an input node NA of the inverter IV1, and the storage capacitor CH2 is connected to an input node NB of the inverter IV2. Additionally, each of the storage capacitors CH1 and CH2 may be a parasitic capacitance.

Input signals IN1 and IN2 illustrated in FIG. 5 are signals which have the same period and are out of phase with each other. The switches SW1 and SW2 operate to be turned on while the input signals IN1 and IN2 are maintained at High (H) level, respectively.

Referring to FIG. 6, now assume that a node NE is set at H level at a time t0. The input signal IN1 changes to H level at a time t0, so that the switch SW1 is turned on. This causes the node NA to be set at H level, and causes the output node NB of the inverter IV1 to be at Low (L) level. In other words, the inverter IV1 operates to invert an output of the inverter IV3 in synchronization with the input signal IN1. Thereafter, when the input signal IN1 returns to L level at a time t1, the switch SW1 is turned off. Nonetheless, the node NB is maintained at L level because the node NA is maintained at H level by the storage capacitor CH1.

Then, when the input signal IN2 changes to H level at a time t2, the switch SW2 is turned on, so that a node NC is set at L level at which also the node NB is maintained. As a result, an output node ND of the inverter IV2 is set at H level, and an output node NE of the inverter IV3 is set at L level. In other words, the inverter IV2 operates to invert an output of the inverter IV1 in synchronization with the input signal IN2. Thereafter, when the input signal IN2 returns to L level at a time t3, the switch SW2 is turned off. Nonetheless, the node ND and the node NE are maintained at H level and L level, respectively, because the node NC is maintained at L level by the storage capacitor CH2.

After that, operations similar to the above-described operations performed at a times t0, t1, t2, and t3, are performed with level relationships among the nodes being reversed. More specifically, the input signal IN1 again changes to H level at a time t4 to turn on the switch SW1, so that the node NA and the node NB are set at L level and H level, respectively. Then, even though the input signal IN1 returns to L level to turn off the switch SW1 at a time t5, the node NB is maintained at H level because the node NA is maintained at L level by the storage capacitor CH1.

Further, when the input signal IN2 changes to H level at a time t6 to turn on the switch SW2, the node NC, the node ND, and the node NE are set at H level, L level, and H level, respectively. Thereafter, even though the input signal IN2 returns to L level to turn off the switch SW2 at a time t7, the nodes ND and NE are maintained at L level and H level, respectively, because the node NC is maintained at H level by the storage capacitor CH2.

The same operations as the above-described operations performed at time t0 to t7 are repeated after a time t7.

As described above, in the circuit illustrated in FIG. 5, the respective levels of the nodes NA and NB are inverted each time the level of the input signal IN1 becomes H, and the respective levels of the nodes ND and NE are inverted each time the level of the input signal IN2 becomes H. In other words, a signal whose period is twice a period of the input signal IN1 or IN2 is supplied to each of the nodes NA, NB, NC, ND, and NE. In particular, the signal supplied to each of the nodes NA and NB is in phase with the input signal IN1, and the signal supplied to each of the nodes NC, ND, and NE is in phase with the input signal IN2.

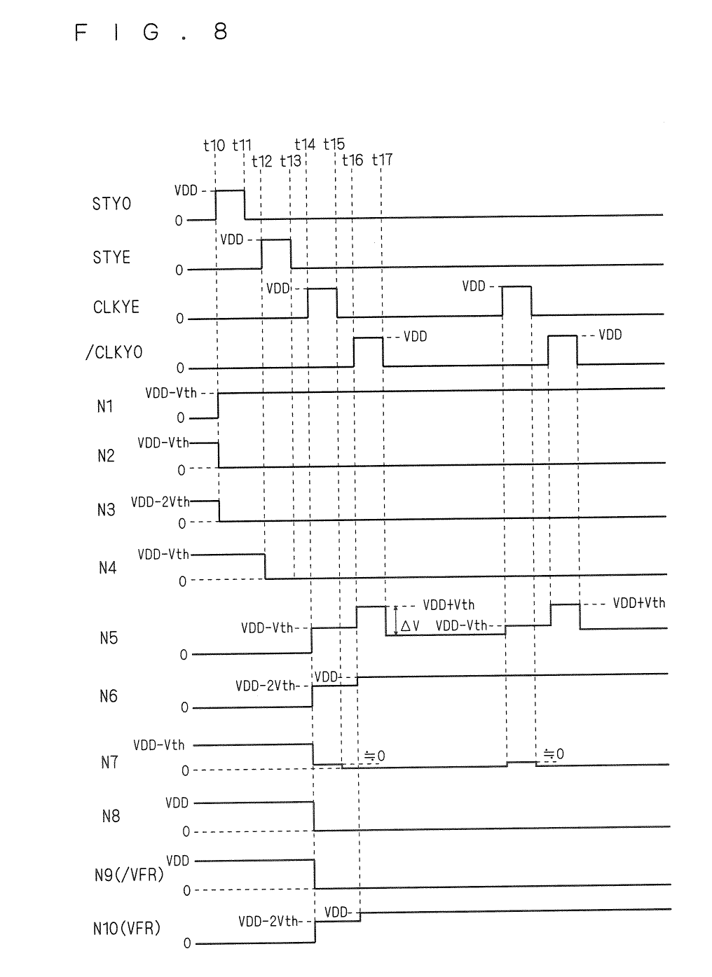

FIG. 7 illustrates an example of a specific circuit configuration of the frequency division circuit 20. As illustrated in FIG. 7, the frequency division circuit 20 is formed using a-Si TFTs of the same conductivity type (n-channel type, in the present example).

A function of each of the a-Si TFTs (which will be hereinafter referred to as “transistors”) forming the frequency division circuit 20 will be described. A transistor Q1, which corresponds to the switch SW1 in FIG. 5, transmits a level of a node N8 to a node N1 based on the start signal STYO (first start signal) input from the drive control circuit 110.

Transistors Q2, Q3, Q4, Q5, and Q6 form a latch/inverter 21 which includes an inverter for inverting a level of the node N1 and outputting the inverted level of the node N1 to a node N2 and a latch for maintaining the levels of the nodes N1 and N2. More specifically, the transistors Q5 and Q6 serve as the inverter and the transistors Q2, Q3, Q4, and Q5 serve as the latch. The inverter including the transistors Q5 and Q6 corresponds to the inverter IV1 (first inverter) in FIG. 5, and the latch including the transistors Q2, Q3, Q4, and Q5 functions as a holding circuit in the same manner as the storage capacitor CH1 in FIG. 5. The reason for the use of the latch as a holding circuit instead of a capacitive element in the frequency division circuit 20 in FIG. 7 is to ensure reliability in maintaining the levels of the nodes N1 and N2 even if an operation cycle of the frequency division circuit 20 is long. Transistors Q7 and Q8 are provided at an output stage of the inverter including the transistors Q5 and Q6, and forms a buffer 22 for enhancing the drivability (an ability to flow a current) of the inverter.

A transistor Q9 corresponds to the switch SW2 in FIG. 5, and transmits a level of a node N3 to a node N4 based on the start signal (second start signal) STYE input from the drive control circuit 110.

Transistors Q10, Q11, Q12, and Q13 form a latch/inverter 23 which includes an inverter for inverting a level of the node N4 and outputting the inverted level of the node N4 to a node N5 and a latch for maintaining the levels of the nodes N4 and N5. More specifically, the transistors Q12 and Q13 serve as the inverter and the transistors Q10, Q11, Q12, and Q13 serve as the latch. The inverter including the transistors Q12 and Q13 corresponds to the inverter IV2 (second inverter) in FIG. 5, and the latch including the transistors Q10, Q11, Q12, and Q13 functions as a holding circuit in the same manner as the storage capacitor CH2 in FIG. 5. The reason for the use of the latch as a holding circuit instead of a capacitive element is the same as described above, namely, to ensure reliability in maintaining the levels of the nodes N4 and N5 even if an operation cycle of the frequency division circuit 20 is long. Transistors Q14 and Q15 forms a buffer 24 provided at an output stage of the inverter including the transistors Q12 and Q13. The buffer 24 functions to enhance the drivability of the inverter including the transistors Q12 and Q13.

In the meantime, also transistors Q22 and Q23 form a buffer 28 which is provided at the output stage of the inverter including the transistors Q12 and Q13 and functions to enhance the drivability of the inverter including the transistors Q12 and Q13. The buffer 28, in particular, functions as an output buffer which is used for outputting the frequency division signal VFR from the frequency division circuit 20 (the buffer 28 will be hereinafter referred to as an “output buffer 28”).

Transistors Q16 and Q17 form an inverter 25 for inverting a level of a node N6 and outputting the inverted level of the node N6 to a node N7. The inverter 25 serves as the inverter IV3 (third inverter) in FIG. 5. Further, transistors Q18 and Q19 form a buffer 26 which is provided at an output stage of the inverter 25 and functions to enhance the drivability of the inverter 25.

In the meantime, also transistors Q20 and Q21 form a buffer 27 which is provided at the output stage of the inverter 25 and functions to enhance the drivability of the inverter 25. The buffer 27, in particular, functions as an output buffer which is used for outputting the frequency division signal /VFR from the frequency division circuit 20 (the buffer 27 will be hereinafter referred to as an “output buffer 27”).

A capacitive element C1 connected between an input terminal for the clock signal /CLKYO and the node N7 (or respective gates of the transistors Q18 and Q20) receives the clock signal /CLKYO and steps up respective voltages of the gates of the transistors Q18 and Q20 (a voltage of an output node of the inverter 25). Likewise, a capacitive element C2 connected between the input terminal for the clock signal /CLKYO and the node N5 (or respective gates of the transistors Q14 and Q22) receives the clock signal /CLKYO and steps up respective voltages of the gates of the transistors Q14 and Q22 (a voltage of an output node of the latch/inverter 23). Each of the capacitive elements C1 and C2 will be hereinafter referred to as a “step-up capacitor”.

Further, transistors Q24 and Q25 are clamping elements for fixing the respective levels of the nodes N5 and N7 whose voltages are stepped up by the step-up capacitors C1 and C2, respectively, at VDD+Vth (where VDD is a power supply voltage, and Vth is a threshold voltage of an a-Si TFT). By controlling a gate voltage of each of the transistors Q14, Q18, Q20, and Q22 such that it does not exceed VDD+Vth, a shift in a threshold voltage of each of those transistors is suppressed.

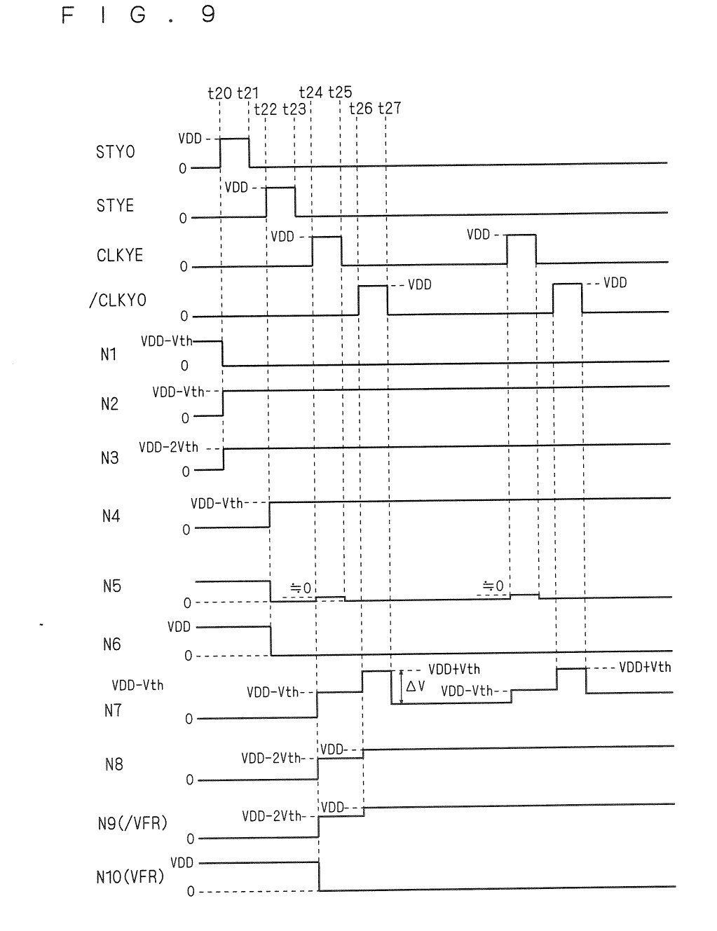

FIGS. 8 and 9 are timing charts showing operations of the frequency division circuit 20 illustrated in FIG. 7. Below, the operations of the frequency division circuit 20 will be described with reference to FIGS. 8 and 9. For convenience of explanation, it is assumed that a potential (VSS) of a power supply maintained at a lower potential (“low level power supply”), which potential serves as a reference potential, is 0, and a potential of a power supply maintained at a higher potential (“high level power supply”) is VDD. Also, it is further assumed that respective potentials of L level and H level of each of the start signals STYO and STYE and the clock signals CLKYO, /CLKYO, CLKYE, and /CLKYE are 0 and VDD, respectively. It should be noted that, in practical applications, the reference potential is determined depending on a level of data written into a pixel, and thus respective potentials of the low level power supply and the high level power supply are set at −12V and +17V, respectively, for example.

First, referring to FIG. 8, assume that the frequency division signal VFR is at L level and the frequency division signal /VFR is at H level immediately before a time t10. At that time, the node N8 is at H level (VDD−Vth), and the node N1 is at L level (0). When the start signal STYO changes to H level (VDD) at a time t10, the transistor Q1 is turned on and the level of the node N8 is transmitted to the node N1. Then, the node N1 is changed to H level (VDD−Vth) because an on-state resistance of the transistor Q3 is set to be much higher than an on-state resistance of each of the transistors Q1 and Q18. Because of the change in the level of the node N1, the transistor Q5 is turned on. Nonetheless, the node N2 is changed from H level (VDD−Vth) to L level because an on-state resistance of the transistor Q5 is set to be much lower than an on-state resistance of each of the transistors Q4 and Q6. As a result, the transistor Q7 is turned off and the transistor Q8 is turned on, so that the output node N3 of the buffer 22 is set at L level (0).

Then, when the start signal STYO changes to L level (0) at a time t11, the transistor Q1 is turned off. Nonetheless, the respective levels of the nodes N1, N2, and N3 remain unchanged by the action of the latch including the transistors Q2, Q3, Q4, and Q5.

When the start signal STYE changes to H level (VDD) at a time t12, the transistor Q9 is turned on and the level of the node N3 is transmitted to the node N4. The node N4 is changed from H level (VDD−Vth) to L level and the transistor Q13 is turned off, because an on-state resistance of the transistor Q10 is set to be much higher than an on-state resistance of each of the transistors Q8 and Q9. However, the clock signal CLKYE is at L level (0) at that time, and thus the output node N5 of the inverter including the transistors Q12 and Q13 is maintained at L level (0).

When the start signal STYE changes to L level (0) at a time t13, the transistor Q9 is turned off. Nonetheless, as the drivability of the transistor Q10 is low because of the sufficiently high on-state resistance thereof as described above, an increase in the level of the node N4 is so slow that the node N4 is maintained at L level until a time t14 at which the clock signal CLKYE next changes to H level.

Then, when the clock signal CLKYE changes to H level (VDD) at a time t14, the transistor Q12 is turned on and the output node N5 of the inverter including the transistors Q12 and Q13 is changed to H level (VDD−Vth). Also, the transistor Q11 is turned on, so that the nodes N4 and N5 are maintained at L level and H level, respectively, by the action of the latch including the transistors Q10, Q11, Q12, and Q13. As a result, the transistor Q14 is turned on and the transistor Q15 is turned off, so that the output node N6 of the buffer 24 is set at H level (VDD—2×Vth).

The change in the level of the node N6 to H level causes the transistors Q17, Q19, and Q21 to be turned on. As the clock signal CLKYE is at H level at that time, the transistor Q16 is turned on. However, the output node N7 of the inverter 25 is set at L level (nearly 0) because an on-state resistance of the transistor Q17 is set to be much lower than an on-state resistance of the transistor Q16.

When the node N7 is set at L level, the transistor Q18 is tuned off and the transistor Q19 is turned on, so that the output node N8 of the buffer 26 is set at L level (0). Also, the transistor Q20 is turned off and the transistor Q21 is turned on, so that the level of the output node N9 of the output buffer 27, which corresponds to the level of the frequency division signal /VFR, becomes L (0).

Further, when the node N8 is set at L level, the transistor Q22 is tuned on and the transistor Q23 is turned off, so that the level of the output node N10 of the output buffer 28, which corresponds to the level of the frequency division signal VFR, becomes H (VDD−2×Vth).

The frequency division signal VFR is input to the gate of the transistor Q2. Accordingly, the transistor Q2 is turned on while the frequency division signal VFR is maintained at H level, to thereby prevent reduction of the level of the node N1 due to current leakage. Also, when the clock signal CLKYE changes to L level (0) at a time t15, the transistors Q12 and Q16 are turned off. As the transistor Q16 is turned off, no current is supplied to the node N7 from the transistor Q16, so that the level of the node N7 becomes 0.

Further, in the frequency division circuit 20 in FIG. 7, when the clock signal /CLKYO changes to H level (VDD) at a time t16, a voltage of the node N5 (respective voltages of the gates of the transistors Q14 and Q22) is stepped up because of capacitive coupling using the step-up capacitor C2. The step-up in the voltage of the node N5 causes the level of the node N5 to be VDD+Vth, so that no loss of a voltage equal to a threshold voltage of the transistor Q22 is produced and the level of the frequency division signal VFR (the level of the node N10) increases to VDD.

At that time, the transistor Q25 connected between the node N5 and the high level power supply (VDD) prevents the level of the node N5 from excessively increasing, to thereby suppress a shift in a threshold voltage of each of the transistors Q14 and Q22. The transistor Q25 is diode-connected with a cathode being connected to the high level power supply (VDD), and serves to prevent the level of the node N5 from exceeding VDD+Vth, as illustrated in FIG. 8. Likewise, the transistor Q24 connected between the node N7 and the high level power supply (VDD) serves to prevent the level of the node N7 from exceeding VDD+Vth (refer to FIG. 9). Additionally, though the level of the node N7 is ready to increase because of capacitive coupling using the step-up capacitor C1 at a time t16, the node N7 is maintained at L level because the transistor Q17 is turned on.

Thereafter, when the clock signal /CLKYO changes to L level (0) at a time t17, the level of the node N5 is reduced by a predetermined voltage ΔV because of capacitive coupling using the step-up capacitor C2. Nonetheless, as a load for the frequency division signal VFR is capacitive in most cases, the level of the node N10 is maintained by the load even if the gate voltage of the transistor Q22 is reduced, so that the level of the frequency division signal VFR is not changed.

Also, in spite of the level reduction by the voltage ΔV in the node N5 at a time t17, the node N5 is charged to the level of VDD−Vth by the transistor Q12 each time the clock signal CLKYE changes to H level (VDD), as illustrated in FIG. 8. Further, a voltage of the node N5 is stepped up to VDD+Vth because of capacitive coupling using the step-up capacitor C2 each time the clock signal /CLKYO changes to H level, so that the level of the frequency division signal VFR (the level of the node N10) is maintained at VDD.

Additionally, when the clock signal CLKYE changes to H level, the transistor Q16 is turned on and a current is supplied to the node N7. Nonetheless, the node N7 is maintained at L level (nearly 0) and the level of the frequency division signal /VFR (the level of the node N9) is maintained at 0 because the transistor Q17 is turned on at that time.

Thereafter, the frequency division signals VFR and /VFR are maintained at H level and L level, respectively, until the start signals STYO and STYE next change to H level.

Next, operations performed when the start signal STYO again changes to H level with the frequency division signals VFR and /VFR being at H level and L level, respectively, (with the nodes N8 and N1 being at L level and H level, respectively) will be described.

Referring to FIG. 9, when the start signal STYO changes to H level (VDD) at a time t20, the transistor Q1 is turned on and the level of the node N8 is transmitted to the node N1, so that the node N1 is set at L level (0). The change in the level of the node N1 to L level causes the transistor Q5 to be turned off, and at the same time, the node N2 is set at H level (VDD−Vth) because the transistor Q6 is turned on. As a result, the transistor Q7 is turned on and the transistor Q8 is turned off, so that the output node N3 of the buffer 22 is set at H level (VDD−2×Vth).

When the start signal STYO changes to L level (0) at a time t21, the transistors Q1 and Q16 are turned off. Nonetheless, the respective levels of the nodes N1, N2, and N3 remain unchanged by the action of the latch including the transistors Q2, Q3, Q4, and Q5.

When the start signal STYE changes to H level (VDD) at a time t22, the transistor Q9 is turned on and the level of the node N3 is transmitted to the node N4. Thus, the node N4 is set at H level to turn on the transistor Q13. At that time, the clock signal CLKYE is at L level, so that the transistor Q12 is turned off and the node N5 is changed to L level (0). The change in the level of the node N5 to L level causes the transistor Q11 to be turned off and causes the level of the node N4 to be equal to VDD−Vth.

As is made clear from the foregoing, when the node N4 is at H level and the node N5 is at L level, the transistor Q14 is turned off and the transistor Q15 is turned on, so that the node N6 is set at L level (0). Though also the transistor Q22 is turned off when the node N5 is at L level, the level of the node N10 is maintained by the capacitive load for the frequency division signal VFR as described above, and thus, the level of the frequency division signal VFR is not changed at that time. Also, though the transistors Q17, Q19, and Q21 are turned off when the node N6 is at L level, the respective levels of the nodes N7, N8, and N9 are not changed because the clock signals CLKYO and /CLKYO are at L level at that time.

Then, the start signal STYE changes to L level (0) at a time t23. However, the respective levels of the nodes N4, N5, and N6 are maintained by the action of the latch including the transistors Q10, Q11, Q12, and Q13.

When the clock signal CLKYE changes to H level (VDD) at a time t24, the transistor Q16 is turned on and the node N7 is set at H level (VDD−Vth). This causes the transistor Q18 to be turned on and the transistor Q19 to be turned off, so that the node N8 is set at H level (VDD−2×Vth). At the same time, the transistor Q20 is turned on and the transistor Q21 is turned off, so that the level of the frequency division signal /VFR (the level of the node N9) becomes H (VDD−2×Vth).

The frequency division signal /VFR is input to the gates of the transistors Q4 and Q10. Accordingly, the transistors Q4 and Q10 are turned on while the frequency division signal /VFR is at H level, to prevent reduction in the respective levels of the nodes N2 and N4 due to current leakage.

On the other hand, when the node N8 is set at H level, the transistor Q22 is turned off and the transistor Q23 is turned on, so that the level of the frequency division signal VFR (the level of the node N10) becomes L (0).

Additionally, when the clock signal CLKYE changes to H level at a time t24, the transistor Q12 is turned on, so that a current is supplied to the node N5, resulting in a slight increase in the level of the node N5. Nonetheless, the node N5 is maintained at L level (nearly 0) because the transistor Q13 is turned on. Also, when the clock signal CLKYE changes to L level (0) at a time t25, the transistors Q12 and Q16 are turned off, so that the level of the node N5 becomes 0.

Further, in the frequency division circuit 20 in FIG. 7, when the clock signal /CLKYO changes to H level (VDD) at a time t26, a voltage of the node N7 (respective voltages of the gates of the transistors Q14 and Q20) is stepped up because of capacitive coupling using the step-up capacitor C1. The step-up in the voltage of the node N7 causes the level of the node N7 to be VDD+Vth, so that no loss of a voltage equal to a threshold voltage of the transistor Q20 is produced and the level of the frequency division signal /VFR (the level of the node N8) increases to VDD.

At that time, the level of the node N7 is controlled not to exceed VDD+Vth by the action of the transistor Q24 connected between the node N7 and the high level power supply (VDD), as illustrated in FIG. 9. Additionally, though also the level of the node N5 is ready to increase because of capacitive coupling using the step-up capacitor C2 at a time t26, the node N5 is maintained at L level because the transistor Q13 is turned on.

Thereafter, when the clock signal /CLKYO changes to L level (0) at a time t27, the level of the node N7 is reduced by the predetermined voltage ΔV because of capacitive coupling using the step-up capacitor C1. Nonetheless, the potential of the frequency division signal /VFR is maintained by the capacitive load, so that the level of the frequency division signal /VFR is not changed.

Also, in spite of the level reduction by the voltage ΔV in the node N7 at a time t27, the node N7 is charged to the level of VDD−Vth by the transistor Q16 each time the clock signal CLKYE changes to H level (VDD), as illustrated in FIG. 9. Further, a voltage of the node N7 is stepped up to VDD+Vth because of capacitive coupling using the step-up capacitor C1 each time the clock signal CLKYO changes to H level, so that the level of the frequency division signal /VFR (the level of the node N9) is maintained at VDD.

The frequency division signals VFR and /VFR are maintained at L level and H level, respectively, until the start signals STYO and STYE next change to H level.

As is appreciated from FIGS. 8 and 9, each of the frequency division signals VFR and /VFR is inverted every period of the start signal STYO or STYE (in other words, every frame period of an image signal). In other words, each of the frequency division signals VFR and /VFR is a signal whose period is twice a period of each of the start signals STYO and STYE. Accordingly, each of the frequency division signals VFR and /VFR can be used as a switching signal for switching between the two output pull-down a-Si TFTs included in the shift register of each of the gate drivers 11 and 12, from frame to frame.

As is made clear from the above-described operations, the switching signal (the frequency division signals VFR and /VFR) is generated by using only the drive control signal (the start signals and the clock signals) output from the general-purpose drive control circuit. Accordingly, it is possible to actuate the gate drivers 11 and 12 of a type which requires switching between the two output pull-down a-Si TFTs from frame to frame (as taught in Soon Young Yoon et al.), with the use of a general-purpose drive control circuit. Thus, it is possible to prevent malfunction of the gate drivers which is likely to occur due to variation in a threshold voltage of an a-Si TFT while suppressing an increase in costs associated with the display device.

Further, as illustrated in FIG. 7, the frequency division circuit 20 includes only a-Si TFTs of the same conductivity type. Hence, the frequency division circuit 20 can be formed on a glass substrate by the same manufacturing processes for the pixel matrix and the gate drivers 11 and 12. Therefore, complication of manufacturing processes and an increase in manufacturing costs can be suppressed.

Moreover, as is appreciated from the above description, the respective levels of the gates of all a-Si TFTs are inverted each time the frequency division signals VFR and /VFR are inverted in the frequency division circuit 20 in FIG. 7. In other words, the gate of each of all the a-Si TFTs is inverted with a period of one frame period and thus is prevented from being continually biased. Accordingly, a shift in a threshold voltage of each of the a-Si TFTs included in the frequency division circuit 20 is suppressed.

Additionally, the transistors Q24 and Q25 are not necessarily required, provided that the level of a stepped-up voltage of each of the nodes N5 and N7 can be appropriately set by appropriately choosing a capacitance value of each of the step-up capacitors C1 and C2 in the frequency division circuit 20 in FIG. 7. Also, if it is not necessary to change H level of the frequency division signals VFR and /VFR from VDD−2×Vth, neither provision of the step-up capacitors C1 and C2 nor input of the clock signal /CLKYO is required. In other words, the frequency division circuit 20 in FIG. 7 can be driven by a two-phase start signal and a clock signal having at least one phase, which are output from the drive control circuit.

Also, though the clock signal CLKYE is used for the purpose of re-charging (refreshing) the nodes N5 and N7 in the frequency division circuit 20 in FIG. 7, any clock signal that can repeatedly change to H level may alternatively be used. Further, in a case where current leakage is so significant that there is a possibility of reducing the respective levels of the nodes N5 and N7 in spite of a refreshing operation using a one-phase clock signal, a configuration which allows the nodes N5 and N7 to be refreshed using a clock signal having two or more phases may be employed. For example, in order to refresh the node N5 using a two-phase clock signal, an additional transistor is provided in parallel with the transistor Q12 and the additional transistor and the transistor Q12 are driven by clock signals out of phase with each other. Likewise, in order to refresh the node N7 using a two-phase clock signal, an additional transistor is provided in parallel with the transistor Q16 and the additional transistor and the transistor Q16 are driven by clock signals out of phase with each other.

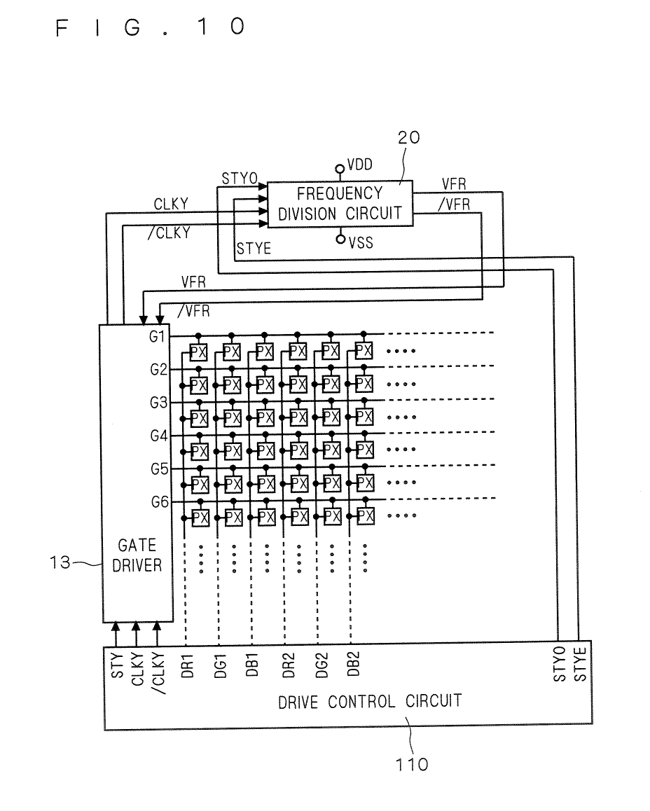

The display device illustrated in FIG. 4 is of a type in which the gate lines of the pixel matrix are driven using two gate drivers, the odd-number gate driver 11 and the even-number gate driver 12. However, the present invention can be applied to a display device of a different type in which the gate lines of the pixel matrix are driven using a single gate driver. An example of the display device of the different type is illustrated in FIG. 10.

To drive the gate lines G1, G2, . . . using a single gate driver 13, a one-phase start signal STY and a two-phase clock signal CLKY, /CLKY are input to the gate driver 13 from the drive control circuit 110, as illustrated in FIG. 10.

As mentioned above, various types of general-purpose drive control circuits (LSI) includes a type that is configured to be able to output a drive control signal adapted to a case where one gate driver is provided and a drive control signal adapted to a case where two gate drivers are provided, to cope with the both cases. The drive control circuit 110 illustrated in FIG. 110 corresponds to that type, and thus can output not only the above-described start signal STY and the clock signal CLKY, /CLKY, but also the two-phase start signal STYO, STYE used in the structure illustrated in FIG. 4 and the four-phase clock signal CLKYO, /CLKYO, CLKYE, /CLKYE, though the four-phase clock signal is not illustrated in FIG. 10.

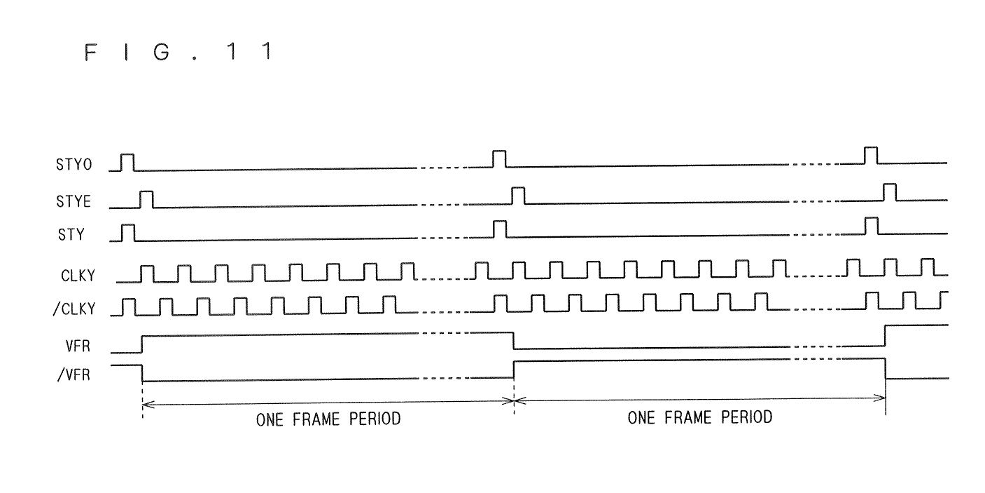

Accordingly, by driving the frequency division circuit 20 using the two-phase start signal STYO, STYE and the two-phase clock signal CLKY, /CLKY as illustrated in FIG. 10, it is possible to obtain the frequency division signals VFR and /VFR each of which is inverted every frame period as illustrated in FIG. 11, by operations similar to the operations performed in the structure illustrated in FIG. 4. Thus, also in the case where the gate lines of the pixel matrix are driven using the single gate driver 13, the same effects as described above can be produced.

Further, though the frequency division circuit 20 is driven using the two-phase start signal STYO, STYE and the two-phase clock signal CLKY, /CLKY in FIG. 10, the two-phase clock signal may be composed of a combination of clock signals different from the clock signals CLKY and /CLKY. For example, the clock signals CLKYE and /CLKYO may be employed. As a matter of course, the clock signals CLKY and /CLKY may be employed in place of the clock signals CLKYE and /CLKYO also in the structure illustrated in FIG. 4.

Also, the start signal STYO and the start signal STY are identical to each other as is appreciated from FIG. 11. Hence, the start signal STY may be employed in place of the start signal STYO in FIG. 10.

Additionally, the first preferred embodiment has been described above, assuming that a semiconductor layer in which thin film transistors forming the pixels, the gate drivers, and the frequency division circuit pixels included in the display device according to the present invention are formed is formed of amorphous silicon (a-Si), and the thin film transistors are a-Si TFTs. However, the present invention can be applied to other cases. The present invention can be applied to a case where an organic TFT, for example, is employed. As an organic TFT and an a-Si TFT suffer from the same problem of a shift in a threshold voltage as mentioned above, and therefore, the present invention is effective for a case where an organic TFT is employed, with the same effects as produced in a case where an a-Si TFT is employed being produced. Also, the fact that the present invention is effective for both cases where an a-Si TFT and an organic TFT are employed, respectively, will hold true in the following preferred embodiments.

### Second Preferred Embodiment

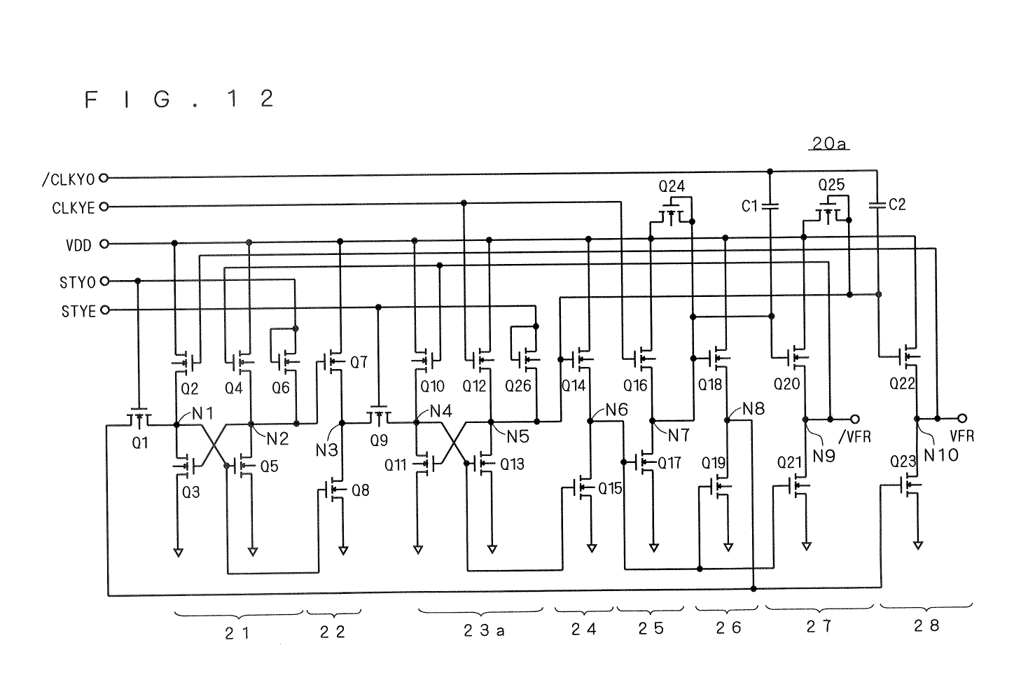

In a second preferred embodiment, an example of a circuit configuration for the frequency division circuit 20, which is different from the circuit configuration illustrated in FIG. 7, will be described. FIG. 12 illustrates a circuit configuration of a frequency division circuit 20a according to the second preferred embodiment.

The frequency division circuit 20a is different from the frequency division circuit 20 in FIG. 7 in that a transistor Q26 is provided between the input terminal for the start signal STYE and the node N5. More specifically, the frequency division circuit 20a includes a latch/inverter 23a including the transistors Q10, Q11, Q12, Q13, and Q26, in place of the latch/inverter 23 in FIG. 7, between the node N1 and the node N5.

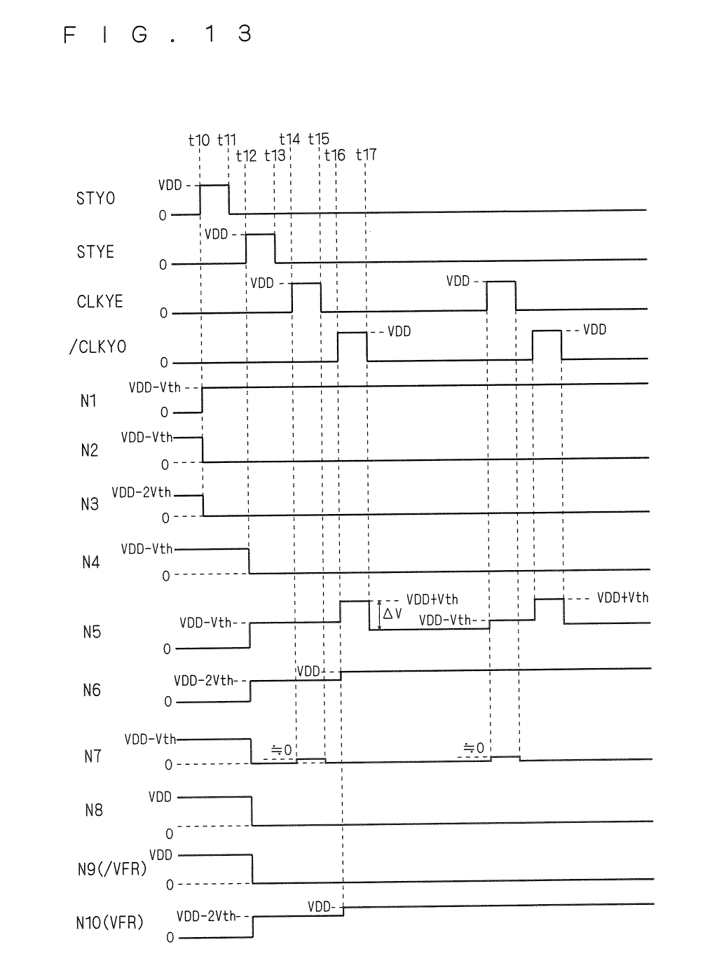

FIG. 13 is a timing chart showing operations of the frequency division circuit 20a. More specifically, operations performed while the frequency division signals VFR and /VFR are transitioning from H level and L level to L level and H level, respectively, are shown in FIG. 13 (thus, FIG. 13 corresponds to FIG. 8 which has been referred to above).

In the frequency division circuit 20 in FIG. 7, the node N5 operates to transition from L level to H level at a time t14 at which the clock signal CLKYE changes to H level, as described above with reference to FIG. 8. In contrast thereto, in the operations of the frequency division circuit 20a shown in FIG. 13, when the start signal STYE is set at H level at a time t12, the transistor Q26 is turned on, so that the node N5 transitions to H level at that time. At the same time, the respective levels of the nodes N6, N7, N8, N9, and N10 are changed at a time t12. The operations of the frequency division circuit 20a are identical to the operations of the frequency division circuit 20 in FIG. 7 except the time at which the levels of the nodes N5 to N10 are changed, and thus, a detailed description of the operations of the frequency division circuit 20a is omitted here.

### Third Preferred Embodiment

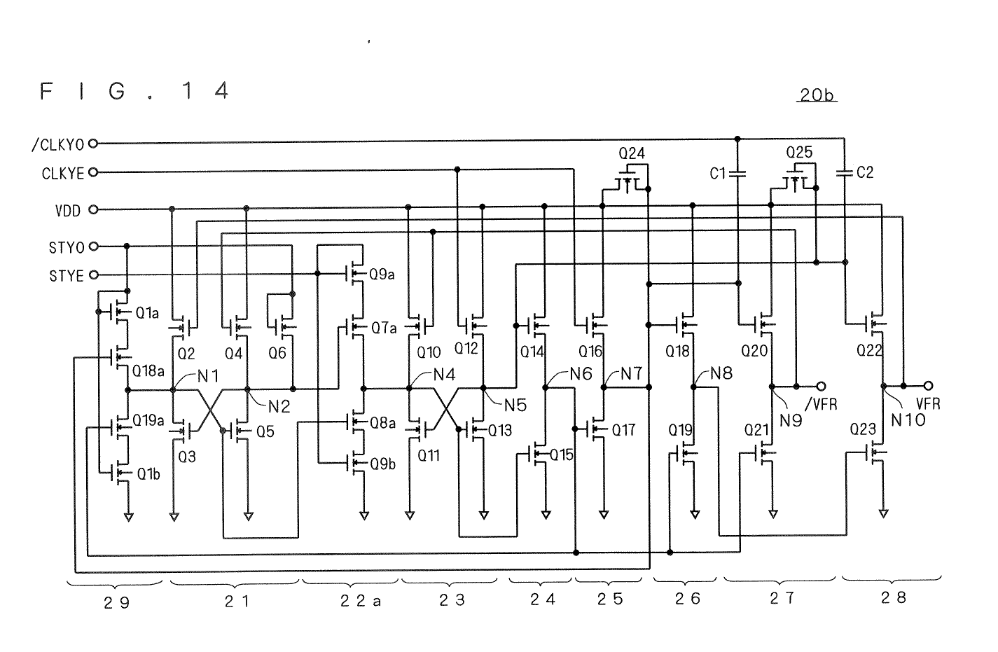

Also in a third preferred embodiment, an example of a circuit configuration for the frequency division circuit 20, which is different from the circuit configuration illustrated in FIG. 7, will be described. FIG. 14 illustrates a circuit configuration of a frequency division circuit 20b according to the third preferred embodiment. The frequency division circuit 20b in FIG. 14 includes a buffer 29 in place of the transistor Q1 in FIG. 7, and further includes a buffer 22a in place of the buffer 22 and the transistor Q9 in FIG. 7. The circuit configuration of the frequency division circuit 20b is identical to that in FIG. 7 in all the other respects.

The buffer 29 includes a buffer circuit including transistors Q18a and Q19a, a transistor Q1a connected between the buffer circuit and the input terminal for the start signal STYO, and a transistor Q1b connected between the buffer circuit and the low level power supply. A gate of the transistor Q18a is connected with the gate of the transistor Q18 (the node N7), and a gate of the transistor Q19a is connected with the gate of the transistor Q19 (the node N6). Respective gates of the transistors Q1a and Q1b are connected with the input terminal for the start signal STYO in common.

Accordingly, while the start signal STYO is at H level, the transistors Q1a and Q1b are turned on, so that the buffer 29 outputs the same level as the level of an output of the buffer 26 (the level of the node N8) to the node N1. Also, the transistors Q1a and Q1b are turned off while the start signal STYO is at L level, the node N1 is electrically separated from the nodes N6 and N7. Thus, the buffer 29 operates in the same manner as the transistor Q1 in FIG. 7.

On the other hand, the buffer 22a includes a buffer circuit including transistors Q7a and Q8a, a transistor Q9a connected between the buffer circuit and the input terminal for the start signal STYE, and a transistor Q9b connected between the buffer circuit and the low level power supply. A gate of the transistor Q7a is connected with the node N2 in the same manner as the transistor Q7 in FIG. 7, and a gate of the transistor Q8a is connected with the node N1 in the same manner as the transistor Q8 in FIG. 7. Respective gates of the transistors Q9a and Q9b are connected with the input terminal for the start signal STYE in common.

Accordingly, the transistors Q9a and Q9b are turned on while the start signal STYE is at H level, so that the buffer 22a outputs the level of the node N2 to the node N4. Also, the transistors Q9a and Q9b are turned off while the start signal STYE is at L level, so that the node N4 is electrically separated from the nodes N1 and N2. Thus, the buffer 22a operates in the same manner as the buffer 22 and the transistor Q9 in FIG. 7.

As is made clear from the above description, the frequency division circuit 20b in FIG. 14 operates in the same manner as the frequency division circuit 20 in FIG. 7. The overall operations of the frequency division circuit 20b are as described in the first preferred embodiment, and thus a description therefor is omitted here.

### Fourth Preferred Embodiment

In the frequency division circuit 20 in FIG. 7 which has been described above, the node N5, for example, is at L level for a half of an operation cycle of the frequency division circuit 20. When the gate of the transistor Q12, which receives the clock signal CLKYE, is set at H level while the node N5 is at L level, the gate of the transistor Q12 is biased positively with respect to the source (node N5). Conversely, when the gate of the transistor Q12 is set at L level while the node N5 is at H level, the gate of the transistor Q12 is biased negatively with respect to the source. Also, if the gate of the transistor Q12 is at L level over the entire operation cycle, the gate of the transistor Q12 is biased negatively with respect to the drain (VDD).

Such application of a positive/negative bias to the gate of the transistor Q12 as described above causes a shift in a threshold voltage of the transistor Q12. In this regard, a shift in a threshold voltage can be more easily caused by application of a positive bias as compared to a negative bias, in general. Hence, the threshold voltage of the transistor Q12 is very likely to be shifted in a positive direction (in other words, increase). An increase in the threshold voltage (Vth) of the transistor Q12 causes reduction of the potential of the node N5 when it is at H level (VDD−Vth), which results in reduction of a potential of the frequency division signal VFR (a potential of the node N10) when it is at H level.

Likewise, the threshold voltage (Vth) of the transistor Q16 is very likely to be shifted in a positive direction. An increase in the threshold voltage of the transistor Q16 causes reduction of a potential of the node N7 when it is at H level (VDD−Vth), which results in reduction of a potential of the frequency division signal /VFR (a potential of the node N9) when it is at H level.

In the frequency division circuit 20 in FIG. 7, level reduction in the nodes N5 and N7 are compensated for by the step-up capacitors C2 and C1, respectively, as described above. Though an increase in a capacity of each of the step-up capacitors C1 and C2 allows for improvement in compensating performance thereof on one hand, the increased capacities of the step-up capacitors C1 and C2 would cause delays in rises of the levels of nodes N5 and N7. Thus, the capacities of the step-up capacitors C1 and C2 have limitations.

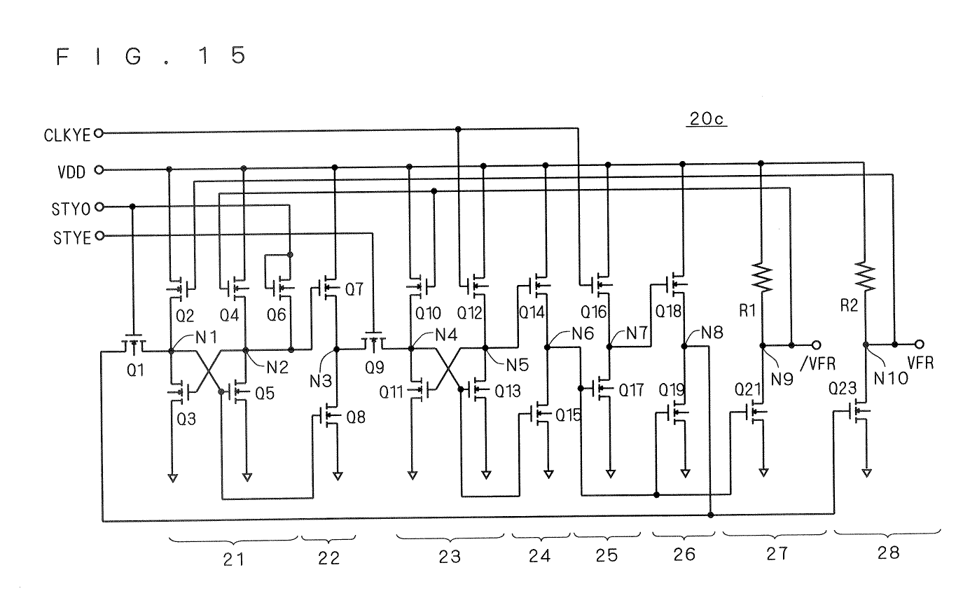

FIG. 15 is a circuit diagram of a frequency division circuit 20c according to a fourth preferred embodiment, which can overcome the foregoing problems. The frequency division circuit 20c in FIG. 15 includes a resistance element R1 in place of the transistor Q20 in FIG. 7 and further includes a resistance element R2 in place of the transistor Q22 in FIG. 7. More specifically, the resistance element R1 is connected between the high level power supply (VDD) and the node N9, and forms the output buffer 27 together with the transistor Q21. The resistance element R2 is connected between the high level power supply and the node N10, and forms the output buffer 28 together with the transistor Q23. The operations of the frequency division circuit 20c are substantially identical to the operations of the frequency division circuit 20 in FIG. 7 which have been described in the first preferred embodiment, and thus a detailed description therefor is omitted here.

In the frequency division circuit 20c in FIG. 15, H level of the frequency division signal VFR is determined via the resistance element R2. Hence, when the transistor Q23 is turned off, the frequency division signal VFR (the node N10) is set at the level of VDD. That is, unlike the frequency division circuit 20 in FIG. 7, the frequency division circuit 20c is configured to prevent the level of the frequency division signal VFR from being affected by the level of the node N5, so that the foregoing problems cannot occur even if the threshold voltage of the transistor Q12 increases.

Likewise, H level of the frequency division signal /VFR is determined via the resistance element R1. Hence, when the transistor Q21 is turned off, the frequency division signal /VFR (the node N9) is set at VDD. That is, unlike the frequency division circuit 20 in FIG. 7, the frequency division circuit 20c is configured to prevent the level of the frequency division signal /VFR from being affected by the level of the node N7, so that the foregoing problems cannot occur even if the threshold voltage of the transistor Q16 increases.

Consequently, there is no need to provide the step-up capacitors C1 and C2 for compensating for the levels of the nodes N5 and N7 and the transistors Q24 and Q25 serving as clamping elements.

Additionally, an increase in the threshold voltage of the transistor Q12 causes reduction of the potential of the node N6 when it is at H level, and likewise, an increase in the threshold voltage of the transistor Q16 causes reduction of the potential of the node N8 when it is at H level. For this reason, the increases in the threshold voltages of the transistors Q12 and Q16 may probably affect also operations of the transistors Q21 and Q23 while they are turned on. A solution to such problem is to appropriately set respective resistance values of the resistance elements R1 and R2 and respective values of on-state resistances of the transistors Q21 and Q23 such that the transistors Q21 and Q23 operate in a non-saturation region. By doing so, it is possible to minimize increases in the potentials of the frequency division signals /VFR (the node N9) and VFR (the node N10) when they are at L level, to a negligible degree.

In general, it is difficult to form a resistance element having a specified resistance value in parallel with manufacturing processes of an a-Si TFTs. For this reason, it is desirable to employ a discrete resistance element as each of the resistance elements R1 and R2. Also, as a discrete resistance element is inexpensive in general, an increase in costs associated with the device which is incurred due to use of the frequency division circuit 20c in FIG. 15 is considered to be so slight that no problem occurs.

Additionally, in the fourth preferred embodiment, the configuration in which the resistance elements RI and R2 are provided in place of the transistors Q20 and Q22 in the frequency division circuit 20 in FIG. 7 has been described. However, the configuration in which the resistance elements R1 and R2 are provided in place of the transistors Q20 and Q22 may alternatively be formed in the frequency division circuit 20a in FIG. 12 or the frequency division circuit 20b in FIG. 14. It is clear that such alternative configurations can produce the same effects as described above.

### Fifth Preferred Embodiment

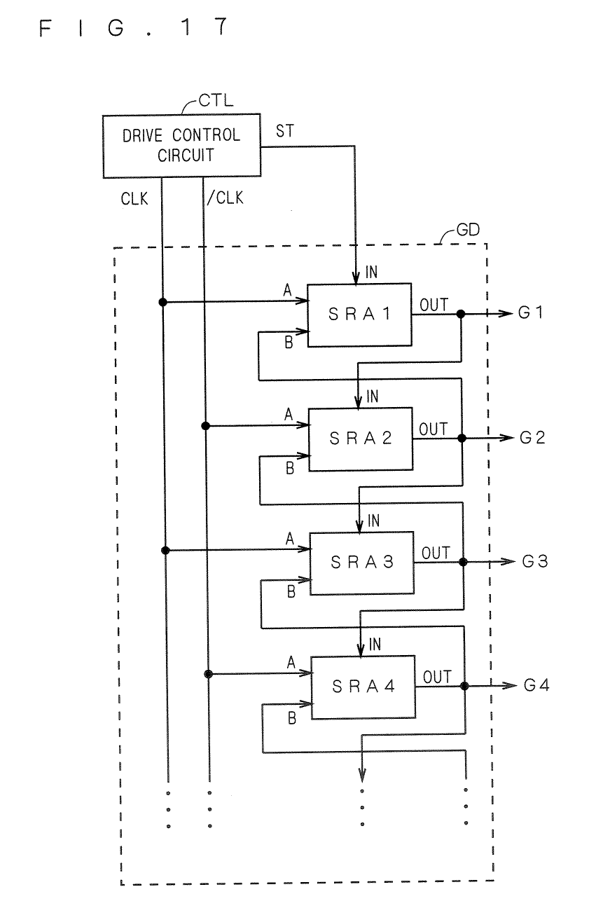

In a fifth preferred embodiment, a specific example of the shift register forming the gate drivers (the above-described gate drivers 11, 12, and 13) applied to the display device according to the present invention will be described. Each of the gate drivers includes a plurality of shift register circuits which are cascaded (refer to FIG. 17). In the following description, each of the plurality of shift register circuits will be referred to as a “unit shift register”.

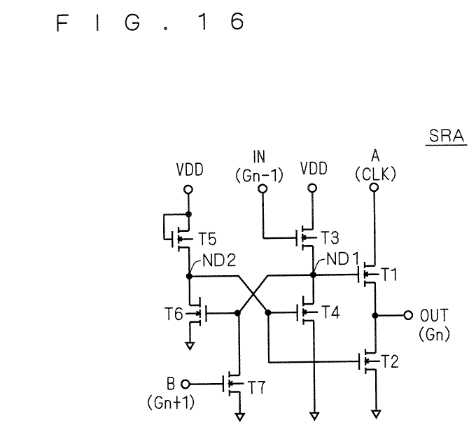

For convenience of explanation, a shift register used in the conventional gate driver will be briefly described, prior to a description of the fifth preferred embodiment. FIG. 16 is a circuit diagram of a unit shift register SRA used in the conventional gate driver.

The unit shift register SRA includes a-Si TFTs each of which is of an n-channel type (which will be hereinafter referred to as “transistors”), and further includes an input terminal IN, an output terminal OUT, a first clock terminal A, and a second clock terminal B. The output terminal OUT corresponds to the output terminal of the gate driver.

An output stage from which a drive signal is output to a gate line Gn in the unit shift register SRA includes a transistor T1 which is connected between the output terminal OUT and the first clock terminal A and a transistor T2 which is connected between the output terminal OUT and the low level power supply (0) and functions to pull down an output. A gate node of the transistor T1 and a gate node of the transistor T2 are defined as a node ND1 and a node ND2, respectively.

A transistor T3 is connected between the node ND1 and the high level power supply (VDD), and a transistor T4 is connected between the node ND1 and the low level power supply. A gate of the transistor T3 is connected to the input terminal IN, and a gate of the transistor T4 is connected to the node ND2. Further, a transistor T5 which is diode-connected is connected between the node ND2 and the high level power supply (VDD), and a transistor T6 is connected between the node ND2 and the low level power supply. A gate of the transistor T6 is connected to the node ND1. Moreover, a transistor T7 is connected between the node ND1 and the low level power supply, and a gate of the transistor T7 is connected to the second clock terminal B.

Also, a gate driver GD includes a plurality of unit shift registers SRA which are cascaded as illustrated in FIG. 17. Each of unit shift registers SRA1, SRA2, . . . illustrated in FIG. 17 is identical to the unit shift register SRA in FIG. 16. The input terminal IN of each of the unit shift registers SRA is connected with the output terminal OUT of one of the unit shift registers SRA which is provided at a preceding stage as illustrated in FIG. 17. However, the input terminal IN of the unit shift register SRA at the first stage is connected with a drive control circuit CTL, and receives a start signal ST for a start of each of frame periods of an image signal.

In the structure illustrated in FIG. 17, the gate driver GD is driven using a one-phase start signal ST and a two-phase clock signal CLK, /CLK which are output from the drive control circuit CTL. In actually driving, one of the clock signals CLK and /CLK is input to the first clock terminal A of each of the unit shift registers SRA such that clock signals of opposite phases are input to adjacent unit shift registers, respectively. Also, the second clock terminal B of each of the unit shift registers SRA is connected to the output terminal OUT of one of the unit shift registers SRA which is provided at a succeeding stage (a gate line Gn+1 at a succeeding stage).

Now, operations of the unit shift register SRA in FIG. 16 will be described. For the purposes of simplification, it is assumed that the clock signal CLK is input to the first clock terminal A of the unit shift register SRA.

First, when the gate line Gn is not selected, the node ND1 and the node ND2 are at L level and H level, respectively, so that the transistor T1 is turned off and the transistor T2 is turned on. Hence, the output terminal OUT (the gate line Gn) is maintained at L level.

Starting from the foregoing state, the output terminal OUT of the unit shift register SRA at a preceding stage (the gate line Gn−1 at a preceding stage) is set at H level, which is then input to the input terminal IN, so that the transistor T3 is turned on. At that time, also the transistor T4 is turned on because the node ND2 is at L level. Nonetheless, the node ND1 is changed to H level because an on-state resistance of the transistor T3 is set to be much lower than an on-state resistance of the transistor T4. As a result, the transistor T1 is turned on.

When the node ND1 is set at H level, the transistor T6 is turned on. As an on-state resistance of the transistor T6 is set to be much lower than an on-state resistance of the transistor T5, the node ND2 is changed to L level. As a result, the transistor T2 is turned off.

In a state where the transistor T1 is turned on and the transistor T2 is turned off, the level of the output terminal OUT changes in accordance with the level of the clock signal CLK. Accordingly, while the clock signal CLK is at H level, the output terminal OUT (the gate line Gn) is set at H level, so that the gate line Gn is selected.

When the gate line Gn is set at H level, the input terminal IN of the unit shift register SRA at a succeeding stage is set at H level. Then, the transistors T1 and T2 of the unit shift register SRA at a succeeding stage are turned on and off, respectively, by the same operations as described above. Thereafter, when the clock signal /CLK changes to H level, the gate line Gn+1 at a succeeding stage is set at H level.

The second clock terminal B is connected to the gate line Gn+1 at a succeeding stage. Hence, when the gate line Gn+l at a succeeding stage is set at H level, the transistor T7 is turned on, so that the initial state in which the node ND1 and ND2 are L level and H level, respectively, in other words, the gate line Gn is not selected, again appears.

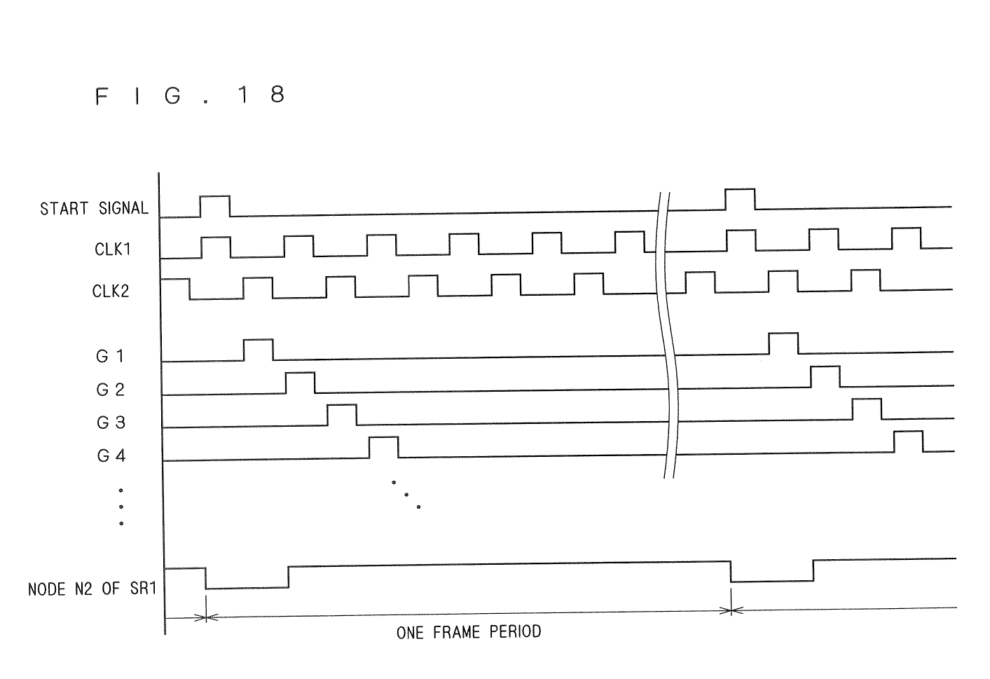

The unit shift registers SRA1, SRA2, . . . which are cascaded as illustrated in FIG. 17 sequentially perform the above-described operations. In this manner, the start signal ST input to the input terminal IN of the unit shift register SRA at the first stage is sequentially transmitted to the unit shift registers SRA2, SRA3, . . . while being shifted in synchronization with the clock signals CLK and /CLK. As a result, the gate driver GD sequentially sets the gate lines G1, G2, G3, . . . at H level in synchronization with the clock signals CLK and /CLK, as shown in the timing chart of FIG. 18.

A voltage waveform at the node ND2 in the unit shift register SRA1 at the first stage is shown at the lowermost level of the timing chart of FIG. 18. Each of the gate lines is selected only once per frame period, and thus, the node ND2 of each of the unit shift registers SRA is maintained at H level except a time period during which the corresponding gate line is selected. In other words, the respective gates of the transistors T2 and T4 are continually biased at almost all times. This causes the above-described problem of a shift in a threshold voltage of an a-Si TFT.

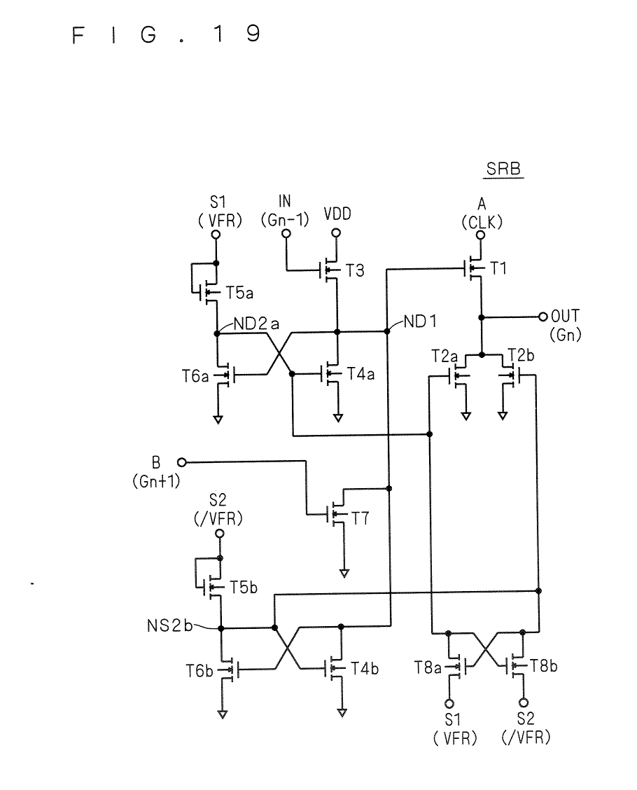

Below, a unit shift register according to the fifth preferred embodiment will be described. FIG. 19 is a circuit diagram of a unit shift register SRB according to the fifth preferred embodiment, which forms a gate driver applicable to the display device according to the present invention. As illustrated in FIG. 19, the unit shift register SRB, like the unit shift register SRA, includes a-Si TFTs each of which is of an n-channel type (which will be hereinafter referred to as “transistors”). However, the unit shift register SRB is different from the unit shift register SRA in that the unit shift register SRB includes an input terminal S1 for the frequency division signal VFR (which will hereinafter be referred to as a “VFR terminal S1”) and an input terminal S2 for the frequency division signal /VFR (which will hereinafter be referred to as a “/VFR terminal S2”), in addition to the input terminal IN, the output terminal OUT, the first clock terminal A, and the second clock terminal B. The output terminal OUT corresponds to the output terminal of the gate driver.

An output stage from which a drive signal is output to a gate line Gn in the unit shift register SRB includes a transistor T1 which is connected between the output terminal OUT and the first clock terminal A, and transistors T2a and T2b for pulling down an output, both of which are connected between the output terminal OUT and the low level power supply. The transistors T2a and T2b are connected in parallel with each other. A gate node of the transistor T1, a gate node of the transistor T2a, and a gate node of the transistor T2b are defined as a node ND1, a node ND2a, and a node ND2b, respectively.

A transistor T3 is connected between the node ND1 and the high level power supply (VDD), and a transistor T4a including a gate connected to the node ND2a and a transistor T4b including a gate connected to the node ND2b are connected between the node ND1 and the low level power supply.

A transistor T5a which is diode-connected is connected between the node ND2a and the VFR terminal S1, and a transistor T6a is connected between the node ND2a and the low level power supply. A transistor T5b which is diode-connected is connected between the node ND2b and the /VFR terminal S2, and a transistor T6b is connected between the node ND2b and the low level power supply. Respective gates of the transistors T6a and T6b are connected to the node ND1 in common.

Further, a transistor T7 is connected between the node ND1 and the low level power supply, and a gate of the transistor T7 is connected to the second clock terminal B.

Moreover, a transistor T8a including a gate connected to the node ND2b is connected between the node ND2a and the VFR terminal S1. Also, a transistor T8b including a gate connected to the node ND2a is connected between the node ND2b and the /VFR terminal S2.

Next, operations of the unit shift register SRB having the above-described structure will be described. For description, consider a situation in which the node ND1 is reset to be at L level by the transistor T7 (in other words, a situation in which the gate line Gn is not selected).

In the foregoing situation, assuming that the frequency division signal VFR is at H level and the frequency division signal /VFR is at L level, the node ND2a is set at H level, so that the transistor T8b is turned on. Also, the node ND2b is set at L level (0) because no current flows into the node ND2b via the transistor T5b. Accordingly, the transistors T2b and T4b are inoperative with the respective gates thereof being not biased. Further, the transistors T5b and T6b do not operate because no current is supplied thereto. In other words, while the frequency division signal VFR is maintained at H level and the frequency division signal /VFR is maintained at L level, a circuit equivalent to the unit shift register SRA illustrated in FIG. 16 is formed of a combination of the transistors T1, T2a, T3, T4a, T5a, T6a, and T7 in the unit shift register SRB.

Conversely, if the frequency division signal VFR is at L level and the frequency division signal /VFR is H level, the node ND2b is set at H level, so that the transistor T8a is turned on. Also, the node ND2a is set at L level (0) because no current flows into the node ND2a via the transistor T5a. Accordingly, the transistors T2a and T4a are inoperative with the respective gates thereof being not biased, in this case. Also the transistors T5a and T6a do not operate. In other words, while the frequency division signal VFR is maintained at L level and the frequency division signal /VFR is maintained at H level, a circuit equivalent to the unit shift register SRA illustrated in FIG. 16 is formed of a combination of the transistors T1, T2b, T3, T4b, T5b, T6b, and T7 in the unit shift register SRB.

Hence, with the use of a plurality of unit shift registers SRB which are cascaded in the same manner as in FIG. 17, the gate driver GD which operates in the same manner as shown in FIG. 18 can be formed. Further, by bringing a pair of the transistors T2a and T4a and a pair of the transistors T2b and T4b into an inoperative state by turns each time the frequency division signals VFR and /VFR are inverted (in other words, every frame period), it is possible to prevent the gates of those pairs of transistors from being continually biased. That is, to use the gate driver GD including the unit shift registers SRB could prevent malfunction which is likely to occur due to a shift in a threshold voltage of an a-Si TFT, to thereby improve the reliability of the display device.

### Sixth Preferred Embodiment

The above-described preferred embodiments have been described with the premise that the drive control circuit 110 which can cope with both of a case in which one gate driver is provided and a case in which two gate drivers are provided is used. However, many of general-purpose drive control circuits can cope with only the case in which one gate driver is provided (in other words, many of general-purpose drive control circuits can output only a one-phase start signal and a two-phase clock signal CLKY, /CLKY). In comparison with a drive control circuit of the type that can cope with both of the foregoing cases, a drive control circuit of the type that can cope with only the case in which one gate driver is provided requires the smaller number of circuits for outputting a control signal, so that associated costs are accordingly reduced. Thus, in a sixth preferred embodiment, a method for driving the frequency division circuit 20 by using the drive control circuit 110 of the type that can cope with only the case in which one gate driver is provided will be described.

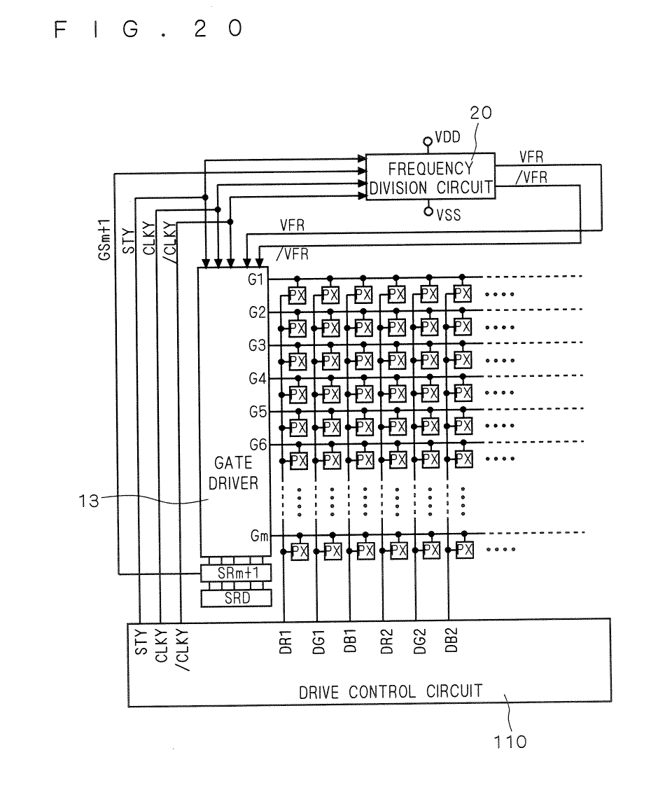

FIG. 20 is a block diagram roughly illustrating a structure of a display device according to the sixth preferred embodiment. As illustrated in FIG. 20, the display device according to the sixth preferred embodiment includes m gate lines G1, G2, . . . Gm, and drives all the m gate lines using a single gate driver 13. The drive control circuit 110 inputs a one-phase start signal STY and a two-phase clock signal CLKY, /CLKY to the gate driver 13, which are also input to the frequency division circuit 20.

The gate driver 13 includes a plurality of unit shift registers which are cascaded. Each of the plurality of unit shift registers is of the same type as the type according to the above-described preferred embodiments (the unit shift register SRB in FIG. 19, for example), more specifically, of the type that switches between two output pull-down a-Si TFTs based on the frequency division signals VFR and /VFR. The number of gate lines which are to be driven by the gate driver 13 is m, and thus the gate driver 13 includes m unit shift registers for respectively driving the m gate lines. The gate driver 13 according to the sixth preferred embodiment further includes a unit shift register SRm+1 at a stage succeeding to the last stage (the m-th stage). The unit shift register SRm+1 may be of either the same type as in FIG. 19, i.e., the type that includes two output pull-down a-Si TFTs, or the conventional type as illustrated in FIG. 16. The unit shift register SRm+1 outputs a signal subsequent to the unit shift register provided at the last stage. Though the signal output from the unit shift register SRm+1 is not used for driving a gate line, the signal output from the unit shift register SRm+1 will be referred to as a “drive signal GSm+1” for convenience of explanation.

The gate driver 13 still further includes a dummy unit shift register SRD at a stage succeeding to the stage at which the unit shift register SRm+1 is provided. The unit shift register SRD outputs a signal subsequent to the unit shift register SRm+1, and the signal output from the unit shift register SRD is used for resetting the unit shift register SRm+1 (more specifically, for turning on the transistor T7 to set the node ND1 at L level in the example illustrated in FIG. 19).

It is noted that though a dummy unit shift register which corresponds to the unit shift register SRD in FIG. 20 and functions to reset a unit shift register provided at the last stage in a cascade connection of the plurality of unit shift registers is usually provided also in each of the gate drivers 101, 102, 11, 12, 13, and the like illustrated in FIGS. 1, 4, and 10, illustration therefor is omitted in those drawings.

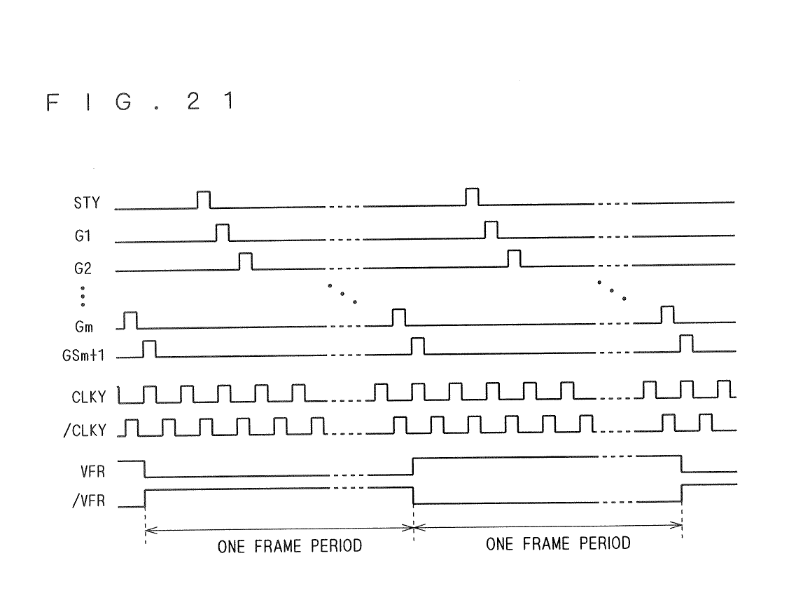

Also in the sixth preferred embodiment, a circuit having any of the configurations illustrated in FIGS. 7, 12, 14, and 15 can be employed as the frequency division circuit 20. According to the sixth preferred embodiment, the start signal STY, the drive signal GSm+1, the clock signal CLKY, and the clock signal /CLKY, in place of the start signal STYO, the start signal STYE, the clock signal CLKYE, and the clock signal /CLKYO, respectively, are input to the frequency division circuit 20 having any of the configurations illustrated in FIGS. 7, 12, 14, and 15. FIG. 21 shows waveforms representing operations of the frequency division circuit 20 according to the sixth preferred embodiment. The start signal STY and a drive signal GSm+1 have the same period of one frame period and are out of phase with each other. As such, based on the theory described above with reference to FIG. 5, each of the frequency division signals VFR and /VFR output from the frequency division circuit 20 is inverted in level thereof each time the drive signal GSm+1 is activated (set at H level). In other words, each of the frequency division signals VFR and /VFR has a period of one frame period (a period corresponding to a frequency which is obtained by halving a frequency of the start signal STY) also in the structure illustrated in FIG. 20.

Accordingly, each of the frequency division signals VFR and /VFR can be used as a switching signal for switching between the two output pull-down a-Si TFTs included in each of the unit shift registers of the gate driver 13 from frame to frame.

As described above, according to the sixth preferred embodiment, even in a case where the drive control circuit 10 can output only the one-phase start signal STY and the two-phase clock signal CLKY, /CLKY which are used in the case in which only a single gate driver is provided, the switching signal (the frequency division signals VFR and /VFR) can be generated. Hence, costs associated with the present invention can be further reduced.

According to the sixth preferred embodiment, an output signal (the drive signal GSm+1) supplied from the unit shift register SRm+1 which is provided additionally to the unit shift registers for driving the pixels, out of the plurality of the unit shift registers included in the gate driver 13, is used for driving the frequency division circuit 20. However, an arbitrary signal which is out of phase with the start signal STY can be employed for driving the frequency division circuit 20, in place of the drive signal GSm+1. For example, an output signal supplied from a predetermined one out of the unit shift registers which are used for driving the gate lines, is also used for driving the frequency division circuit 20. This produces an advantage of eliminating a need of additionally providing the unit shift register SRm+1. On the other hand, however, it is necessary to keep it in mind that the multipurpose use of the predetermined unit shift register may cause a disadvantage of increasing a load on the predetermined unit shift register for driving the frequency division circuit 20, to reduce a driving speed of a gate line which is driven by the predetermined unit shift register.

### Seventh Preferred Embodiment

As described above, the circuit having any of the configurations illustrated in FIGS. 7, 12, 14, and 15 can be employed as the frequency division circuit 20 according to the sixth preferred embodiment. However, to employ the circuit having any of the configurations illustrated in FIGS. 7, 12, 14, and 15 as the frequency division circuit 20 according to the sixth preferred embodiment may bring the following problems.

For example, consider a case in which the frequency division circuit 20 illustrated in FIG. 7 is applied to the sixth preferred embodiment. In this case, the start signal STY is input to the gate of the transistor Q1 of the frequency division circuit 20, and the drive signal GSm+1 is input to the gate of the transistor Q9. The start signal STY is associated with a start of each of frame periods of an image signal, and on the other hand, the drive signal GSm+1 is activated after the m-th gate line Gm is activated. Thus, a time interval of one frame period is left between a time at which the start signal STY is activated and a time at which the drive signal GSm+1 is activated. Accordingly, a time interval between a time at which the transistor Q1 is turned on and a time at which the transistor Q9 is turned on, in other words, a time interval between a time at which the respective levels of the nodes N1, N2, and N3 in FIG. 7 are changed and a time at which the respective levels of the nodes N4 to N10 in FIG. 7 are changed is as long as one frame period.

Hence, even if the transistor Q1 is turned on based on the start signal STY so that the node N1 is changed from H level to L level, for example, the frequency division signal VFR (the node N10) does not change to L level immediately after the change of the level of the node N1 and is maintained at H level for one frame period after the change of the level of the node N1. While the frequency division signal VFR is maintained at H level, the transistors Q2 and Q3 are turned on, so that a through current flows through the transistors Q2 and Q3, resulting in an increase in power consumption. Also, while the frequency division signal VFR is maintained at H level, the frequency division signal /VFR (the node N9) is maintained at L level, so that the transistors Q4 and Q5 are turned off. As such, there is a concern that the potential of the node N2 which should be at H level may be reduced due to current leakage in the transistor Q5, to cause malfunction.

Conversely, in a case where the node N1 is changed from L level to H level based on the start signal STY, the frequency division signal VFR (the node N10) is maintained at L level for one frame period after the change of the level of the node N1. While the frequency division signal VFR is maintained at L level, the transistors Q2 and Q3 are turned off, to cause a concern that the potential of the node N1 may be reduced due to current leakage in the transistor Q3. Also, while the frequency division signal VFR is maintained at L level, the frequency division signal /VFR (the node N9) is maintained at H level, so that the transistors Q4 and Q5 are turned on, to allow a through current to flow therethrough. The same problems as described above are caused also in the circuits illustrated in FIGS. 12, 14, and 15.

As described above, in the case in which the circuit having any of the configurations illustrated in FIGS. 7, 12, 14, and 15 is employed as the frequency division circuit 20 according to the sixth preferred embodiment (FIG. 20), the problem of malfunction due to an increase in power consumption and current leakage may be caused. In view of this, in a seventh preferred embodiment, the frequency division circuit 20 which can be suitably used in the display device according to the sixth preferred embodiment will be described.

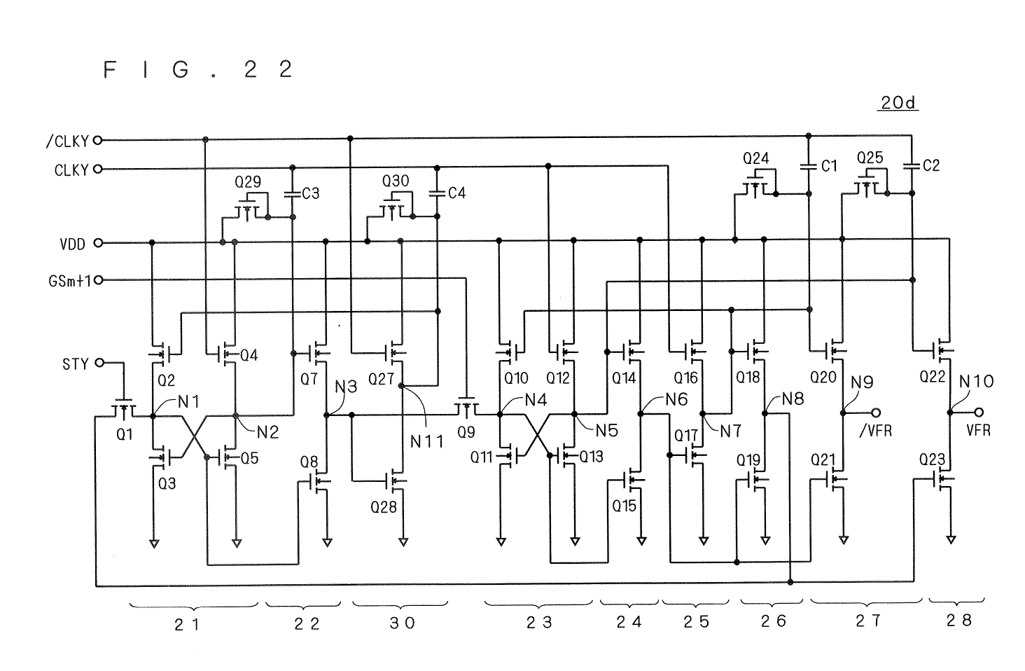

FIG. 22 illustrates a circuit configuration of a frequency division circuit 20d according to the seventh preferred embodiment. In FIG. 22, elements having the same functions as those illustrated in FIG. 7 are denoted by the same reference numerals as in FIG. 7, and thus, elements which distinguish the configuration according to the seventh preferred embodiment from the configuration in FIG. 7 will be mainly described as follows.

As illustrated in FIG. 22, the start signal STY is input to the gate of the transistor Q1 and the drive signal GSm+1 is input to the gate of the transistor Q9. In the seventh preferred embodiment, it is assumed that the start signal STY is activated in synchronization with the clock signal /CLKY (that is, the gate line G1 is activated in synchronization with the clock signal CLKY), and the drive signal GSm+1 is activated in synchronization with the clock signal CLKY (that is, the gate line Gm is activated in synchronization with the clock signal /CLKY).

One of features of the frequency division circuit 20d lies in inclusion of an inverter 30 connected to the output node of the buffer 22. The inverter 30 is not included in the basic configuration of the frequency division circuit illustrated in FIG. 5, and does not directly affect logic operations of the frequency division circuit 20d. The inverter 30 includes a transistor Q27 and a transistor Q28, and outputs a signal obtained by inverting an output of the buffer 22, to the node N11. In FIG. 7, the gate of the transistor Q2 is connected to the node N10 serving as the output terminal for the frequency division signal VFR. In contrast thereto, according to the seventh preferred embodiment, the gate of the transistor Q2 is connected to the node N11.

The gate of the transistor Q4 of the latch/inverter 21 and the gate of the transistor Q27 of the inverter 30 are connected to the input terminal for the clock signal /CLK. Also, the gate of the transistor Q12 of the latch/inverter 23 and the gate of the transistor Q16 of the inverter 25 are connected to the input terminal for the clock signal CLKY. Further, the gate of the transistor Q10 of the latch/inverter 23 is connected to the output node (the node N7) of the inverter 25.

A step-up capacitor C3 is connected between the input terminal for the clock signal CLKY and the node N2 (the output node of the latch/inverter 21), and a step-up capacitor C4 is connected between the input terminal for the clock signal CLKY and the node N11 (the output node of the inverter 30). Also, a transistor Q29 which is diode-connected is connected between the node N2 (one end of the step-up capacitor C3) and the high level power supply (VDD), and likewise, a transistor Q30 which is diode-connected is connected between the node N11 (one end of the step-up capacitor C4) and the high level power supply (VDD). The transistors Q29 and Q30 are clamping elements for fixing the respective levels of the nodes N2 and N11 which are stepped up by the step-up capacitors C3 and C4, respectively, at VDD+Vth (where VDD is a power supply voltage, and Vth is a threshold voltage of an a-Si TFT). The transistors Q29 and Q30 control respective gate voltages of the transistors Q2, Q3, and Q7 such that each of the gate voltages does not exceed VDD+Vth, to thereby suppress a shift in a threshold voltage of each of the transistors.

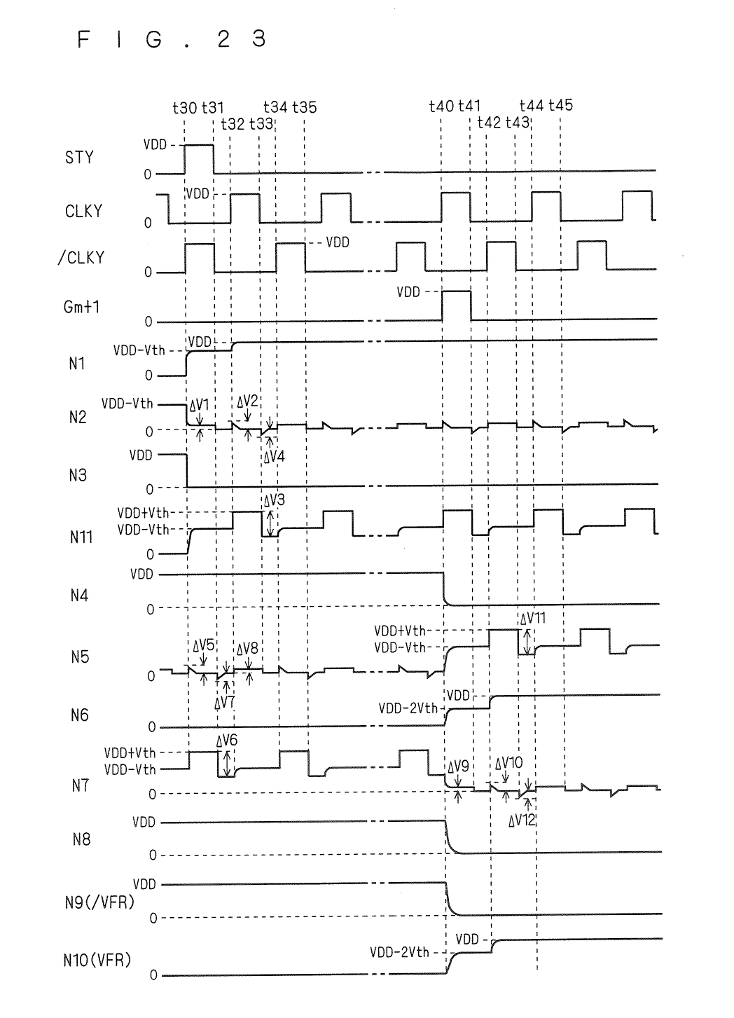

FIG. 23 is a timing chart for explaining operations of the frequency division circuit 20d according to the seventh preferred embodiment. Below, the operations of the frequency division circuit 20d will be described in detail with reference to FIG. 23. For the description, it is assumed that the frequency division signal VFR (the node N10) is at L level and the frequency division signal /VFR (the node N9) is at H level immediately before a time t30. At that time, the node N8 is at H level (VDD), and the node N1 is at L level (0).

For convenience of explanation, changes in the levels of the nodes N1, N2, N3, and N11 will be described first. At a time t30, the clock signal /CLKY changes to H level, and at the same time, the start signal STY changes to H level (VDD). Then, the transistor Q1 is turned on, so that H level of the node N8 is transmitted to the node N1. As a result, the level of the node N1 is changed to VDD−Vth which is equal to the level of the node N8 minus the threshold voltage (Vth) of the transistor Q1. The change in the level of the node N1 to H level causes the transistor Q5 to be turned on. At that time, as the clock signal /CLKY is at H level, the transistor Q4 is turned on. Nonetheless, the node N2 is set at L level because the on-state resistance of the transistor Q4 is set to be much higher than the on-state resistance of the transistor Q5. More specifically, the node N2 is set at L level which is higher than the potential level of the low level power supply (0) by a voltage ΔV1 (refer to FIG. 23) which is determined depending on a ratio between the respective on-state resistances of the transistors Q4 and Q5.

When the node N1 and the node N2 are set at H level and L level, respectively, the transistors Q7 and Q3 are turned off and the transistor Q8 is turned on. Accordingly, the node N3 is set at L level (0), so that the transistor Q28 is turned off. At that time, as the clock signal /CLKY is at H level, the transistor Q27 is turned on, so that the node N11 is set at H level (VDD−Vth) and the transistor Q2 is turned on. As a result, the nodes N1 and N2 are maintained at H level and L level, respectively, by the transistors Q2, Q3, and Q4 which form a flip-flop (latch).

Then, when the start signal STY and the clock signal /CLKY return to L level at a time t31, the transistor Q1 is turned off so that the nodes N8 and N1 are separated from each other. Nonetheless, the level of the node N1 is not changed from VDD−Vth because the transistor Q3 is turned off. Also, as the transistor Q4 is turned off, the node N2 is at a potential of ΔV with the voltage ΔV1 being no longer added thereto. The level of the node N3 is not changed and remains L. Further, though the transistor Q27 is turned off, also the transistor Q28 is turned off, so that the node N11 is maintained by a parasitic capacitance of the transistor Q28, to be set at H level (VDD−Vth) at which the node N11 is floating.

When the clock signal CLKY changes to H level at a time t32, the voltage of the node N11 is stepped up because of capacitive coupling using the step-up capacitor C4. However, the level of the node N11 is fixed at VDD+Vth by the action of the transistor Q30 as a clamping element. As a result, the transistor Q2 operates in a non-saturation region (non-saturation operation), and the potential of the node N1 when it is at H level increases to VDD.

Likewise, the voltage of the node N2 is stepped up because of capacitive coupling using the step-up capacitor C3. Nonetheless, the step-up in the voltage of the node N2 is small (by a voltage ΔV2 shown in FIG. 23) because the transistor Q5 is turned on, and the voltage of the node N2 returns to 0V in response to a complete rise of the clock signal CLKY. That is, the node N2 is maintained at L level, so that the node N3 is maintained at L level (0).

When the clock signal CLKY changes to L level at a time t33, the voltage of the node N11 is reduced by a predetermined voltage ΔV3 because of capacitive coupling using the step-up capacitor C4, so that the transistor Q2 is turned off. Nonetheless, the level of the node N1, which is maintained by a parasitic capacitance thereof, remains VDD. Likewise, though the voltage of the node N2 is reduced by a predetermined voltage ΔV4 because of capacitive coupling using the step-up capacitor C3, the voltage of the node N2 returns to 0V in response to a complete fall of the clock signal CLKY because the transistor Q5 is turned on. That is, the node N2 is maintained at L level, so that the node N3 is maintained at L level (0).

Subsequently, when the clock signal /CLKLY again changes to H level at a time t34, the transistor Q4 is turned on, so that the node N2 is at a potential higher than the potential of the low level power supply (0) by the voltage ΔV1. Nonetheless, the node N2 is maintained at L level. Also, the transistor Q27 is turned on, so that the level of the node N11 becomes equal to VDD+Vth.

Then, when the clock signal /CLKY returns to L level at a time t35, the transistor Q4 is turned off, so that the node N2 is at a potential of 0V with the voltage ΔV1 being no longer added thereto. Also, the transistor Q27 is turned off, and the node N11 is set at H level (VDD−Vth) at which the node N11 is floating.

Thereafter, the above-described operations performed at times t32, t33, t34, and t35 are repeated in the nodes N1, N2, N3, and N11 each time the clock signals CLKY and /CLKY are input, until the start signal STY is next activated. Thus, respective logic values (H level or L level) of the nodes N1, N2, N3, and N11 are maintained until the start signal STY is next activated.

On the other hand, respective logic values (H level or L level) of the nodes N4 to N10 are not changed for a time period from a time t30 to a time t35. Though the node N10 is at L level and the nodes N8 and N9 are at H level immediately before a time t30 as described above, the nodes N4 and N7 are at H level and the nodes N5 and N6 are at L level at that time as shown in FIG. 23.

At a time t30 at which the clock signal /CLKY changes to H level, the voltage of the node N7 which has been at H level at which the node N7 should be floating is stepped up because of capacitive coupling using the step-up capacitor C1 (the node N7 is set at a level of VDD+Vth by the action of the transistor Q24 as a clamping element). At the same time, the transistor Q10 performs a non-saturation operation, so that the node N4 is maintained at H level (VDD). Also, the voltage of the node N5 which has been at L level (0) is stepped up because of capacitive coupling using the step-up capacitor C2. Nonetheless, the step-up in the voltage of the node N5 at that time is small (by a voltage ΔV5 shown in FIG. 23) because the transistor Q13 is turned on, and the voltage of the node N5 returns to 0V in response to a complete rise of the clock signal /CLKY. Accordingly, the transistor Q14 is maintained in an off state and the transistor Q15 is maintained in an on state, so that the node N6 is maintained at L level (0). Hence, the transistors Q19 and Q20 are maintained in an off state. On the other hand, as the level of the node N7 is VDD+Vth, the transistors Q18 and Q20 are turned on, so that the nodes N8 and N9 are maintained at H level (VDD). Further, at that time, the transistor Q22 is turned off and the transistor Q23 is turned on, so that the node N10 is maintained at L level (0).

At a time t31 when the clock signal /CLKY returns to L level, the level of the node N7 is reduced from VDD+Vth by a predetermined voltage ΔV6 because of capacitive coupling using the step-up capacitor C1, so that the transistor Q10 is turned off. However, the level (VDD) of the node N4 is maintained by a parasitic capacitance of the node N4. Likewise, though the transistors Q18 and Q20 are turned off, the respective levels of the nodes N8 and N9 are maintained at VDD by respective parasitic capacitances thereof. Also, the level of the node N5 is changed in a negative direction by a predetermined voltage ΔV7 because of capacitive coupling using the step-up capacitor C2. Nonetheless, the level of the node N5 returns to 0V in response to a complete fall of the clock signal /CLKY because the transistor Q13 is turned on. As such, the node N5 is maintained at L level and the node N8 is maintained at H level, so that the node N10 is maintained at L level (0).

At a time t32 at which the clock signal CLKY changes to H level, the transistor Q12 is turned on, so that the node N5 is set at a potential which is higher than the potential of the low level power supply (0) by a voltage ΔV8 which is determined depending on a ratio between the respective on-state resistances of the transistors Q12 and Q13. Nonetheless, the node N5 is maintained at L level. Also, the transistor Q16 is turned on, and the level of the node N7 returns to VDD−Vth. The foregoing behaviors of the nodes N5 and N7 do not cause any change in the levels of the nodes N4, N8, N9, and N10.

Then, at a time t33 at which the clock signal CLKY returns to L level, the transistor Q12 is turned off, so that the node N5 is at a potential of 0V with the voltage ΔV8 being no longer added thereto. Further, the transistor Q16 is turned off, and the node N7 is set at H level (VDD−Vth) at which the node N7 is floating. The foregoing behaviors of the nodes N5 and N7 do not cause any change in the levels of the nodes N4, N8, N9, and N10, also.

At a time t34 and later, the above-described operations performed at times t30, t31, t32, and t33 are repeated in the nodes N4 to N10 each time the clock signals CLKY and /CLKY are input, until the drive signal GSm+1 is next activated. In other words, respective logic values (H level or L level) of the nodes N4 to N10 are maintained until the drive signal GSm+1 is next activated.

Then, at a time t40 which lags one frame period behind a time t30, the drive signal GSm+1 changes to H level (VDD). Operations of the frequency division circuit 20d at a time t40 and later will be now described. As described above, the operations performed at times t32, t33, t34, and t35 are repeated in the nodes N1, N2, N3, and N11 until the start signal STY is next activated, and thus the respective logic values (H level or L level) of the nodes N1, N2, N3, and N11 are maintained. On the other hand, the following operations are performed in the nodes N4 to N10 at a time t40 and later.

When the drive signal GSm+1 changes to H level at a time t40, the transistor Q9 is turned on and L level of the node N3 is transmitted to the node N4, so that the transistors Q13 and Q15 are turned off. At that time, as the clock signal CLKY is at H level, the transistors Q12 and Q16 are turned on. Accordingly, the node N5 is set at H level (VDD−Vth) and the transistor Q11 is turned on. At the same time, the transistor Q14 is turned on and the node N6 is set at H level (VDD−2×Vth). Both of the transistors Q16 and Q17 are in an on state at that time. Nonetheless, the node N7 is set at L level because an on-state resistance of the transistor Q16 is set to be much higher than an on-state resistance of the transistor Q17. More specifically, the node N7 is set at L level which is higher than the level of the low level power supply VSS (0) by a predetermined voltage ΔV9 which is determined depending on a ratio between the respective on-state resistances of the transistors Q16 and Q17.

As a result, the transistor Q10 is turned off, so that the nodes N4 and N5 are maintained at L level (0) and H level (VDD−Vth), respectively, by the transistors Q10, Q11, Q12, and Q13 which form a flip-flop (latch).

Further, as the node N6 is at H level and the node N7 is at L level, the transistor Q19 is turned on and the transistor Q18 is turned off, so that the node N8 is set at L level. Likewise, the transistor Q21 is turned on and the transistor Q20 is turned off, so that the node N9 (/VFR) is set at L level. Further, as the node N5 is at H level and the node N8 is at L level, the transistor Q22 is turned on and the transistor Q23 is turned off, so that the node N10 (VFR) is set at H level (VDD−2×Vth).

Then, when each of the drive signal GSm+1 and the clock signal CLKY changes to L level (0) at a time t41, the transistor Q16 is turned off, so that the node N7 is at a potential of 0V with the voltage ΔV9 being no longer added thereto. Additionally, the respective levels of the nodes N4, N5, N6, N8, N9, and N10 are not changed at that time.

Subsequently, when the clock signal /CLKY changes to H level at a time t42, the level of the node N5 is increased from VDD−Vth because of capacitive coupling using the step-up capacitor C2. At that time, the level of the node N5 is fixed at VDD+Vth by the action of the transistor Q25 as a clamping element. As a result, the transistors Q14 and Q22 perform a non-saturation operation, so that the respective levels of the nodes N6 and N10 (VFR) are set at VDD. Likewise, though the voltage of the node N7 is stepped up because of capacitive coupling using the step-up capacitor C4, the step-up in the voltage of the node N7 is small (by a voltage ΔV10 shown in FIG. 23) because the transistor Q17 is turned on, and the voltage of the node N7 returns to 0V in response to a complete rise of the clock signal /CLKY. As such, the node N7 is maintained at L level, so that the transistors Q10, Q18, and Q20 are maintained in an off state and the nodes N4, N8, and N9 are maintained at L level (0).

When the clock signal /CLKY changes to L level at a time t43, the level of the node N5 is reduced from VDD+Vth by a predetermined voltage ΔV11 because of capacitive coupling using the step-up capacitor C2. This causes the transistors Q14 and Q22 to be turned off. Nonetheless, the nodes N6 and N10, the levels (VDD) of which are maintained by respective parasitic capacitances thereof, are maintained at H level. On the other hand, though the level of the node N7 is changed in a negative direction by a predetermined voltage ΔV12 because of capacitive coupling using the step-up capacitor C1, the level of the node N7 returns to 0V in response to a complete fall of the clock signal /CLKY. As such, the node N6 is maintained at H level and the node N7 is maintained at L level, so that the node N9 is maintained at L level (0).

Then, at a time t44 at which the clock signal CLKY again changes to H level, the transistor Q12 is turned on, so that the level of the node N5 returns to VDD−Vth. Also, the transistor Q16 is turned on, and the node N7 is set at a potential which is higher than the potential of the low level power supply (0) by the predetermined voltage ΔV9. Nonetheless, the node N7 is maintained at L level. The respective levels of the nodes N4, N8, N9, and N10 are not changed at that time.

Then, at a time t45 at which the clock signal CLKY returns to L level, the transistor Q12 is turned off, so that the node N5 is at H level (VDD−Vth) at which the node N5 is floating. Also, the transistor Q16 is turned off, and the node N7 is at a potential of 0V with the voltage ΔV9 being no longer added thereto. The respective levels of the nodes N4, N8, N9, and N10 are not changed at that time, also.

After a time t45, the above-described operations performed at times t42, t43, t44, and t45 are repeated in the nodes N4 to N10 each time the clock signals CLKY and /CLKY are input, until the drive signal GSm+1 is next activated. In other words, the respective logic values (H level or L level) of the nodes N4 to N10 are maintained until the drive signal GSm+1 is next activated.

Then, when the start signal STY next changes to H level, the level of the node N8 becomes L (0), so that the buffer 22d operates as shown by the waveforms at times t30 to t35 in FIG. 23 with the levels thereof being reversed. Accordingly, when the drive signal GSm+1 changes to H level after one frame period passes since the time when the start signal STY changes to H level, the buffer 22d operates as shown by the waveforms at times t40 to a time t45 in FIG. 23 with the levels thereof being reversed. In other words, the frequency division circuit 20d operates to invert the frequency division signals VFR and /VFR each time the drive signal GSm+1 is activated. Therefore, each of the frequency division signals VFR and /VFR has a period of one frame period.

As is made clear from the above-described operations, in the frequency division circuit 20d according to the seventh preferred embodiment, when the node N1 is changed from L level to H level, for example, the transistor Q2 is turned on and the transistor Q4 is turned off at the substantially same time as the change in the level of the node N1. Conversely, when the node N1 is changed from H level to L level, the transistor Q2 is turned off and the transistor Q4 is turned on at the substantially same time as the change in the level of the node N1. Therefore, the frequency division circuit 20d does not suffer from the problem of malfunction due to an increase in power consumption and current leakage, which problem is caused in a case where the circuit illustrated in FIGS. 7, 12, 14, or 15 is employed as the frequency division circuit 20 according to the six preferred embodiment (FIG. 20).

Also, as the basic operations of the frequency division circuit 20d according to the seventh preferred embodiment are the same as described above with reference to FIG. 5, the frequency division circuit 20d can be applied to the display devices illustrated in FIGS. 4 and 10.

Further, because of inclusion of the step-up capacitors C3 and C4 for stepping up the voltages of the nodes N2 and N1, respectively, in accordance with the clock signal CLKY, the frequency division circuit 20d in FIG. 22 allows the transistors Q2 and Q7 to perform a non-saturation operation while the nodes N1 and N3 are re-charged, so that H level of each of the nodes N1 and N3 is increased to VDD. In particular, a threshold voltage of each of the transistors Q2 and Q4 is easy to be shifted because the gate of each of the transistors Q2 and Q4 repeatedly receives the clock signal /CLKY and is repeatedly set at H level. This may reduce the drivabilities of the transistors Q2 and Q4, to thereby cause a concern that a potential of each of the nodes N1 and N2 when it is at H level is reduced. However, this problem can be overcome by the action of the foregoing step-up capacitors C3 and C4.

Moreover, when the step-up capacitors C3 and C4 step up the voltages of the nodes N2 and N11, respectively, the respective levels of the nodes N2 and N11 are prevented from exceeding VDD+Vth by the action of the transistors Q29 and Q30 as clamping elements. Thus, an increase in a shift in a threshold voltage of each of the transistors Q2 and Q4 is avoided by the foregoing manner of stepping up the voltages of the nodes N2 and N11.

Additionally, an output signal (the drive signal GSm+1) of the unit shift register SRm+1 which is provided distinctly from the unit shift registers for driving the pixels is also used for driving the frequency division circuit 20d according to the seventh preferred embodiment. However, an output signal of a predetermined one out of the unit shift registers for driving the gate lines may be also used for driving the frequency division circuit 20d. This produces an advantage of eliminating a need of additionally providing the unit shift register SRm+1. On the other hand, however, it is necessary to keep it in mind that the multipurpose use of the predetermined unit shift register may cause a disadvantage of increasing a load on the predetermined unit shift register for driving the frequency division circuit 20d, to reduce a driving speed of a gate line which is driven by the predetermined unit shift register.

### Eighth Preferred Embodiment

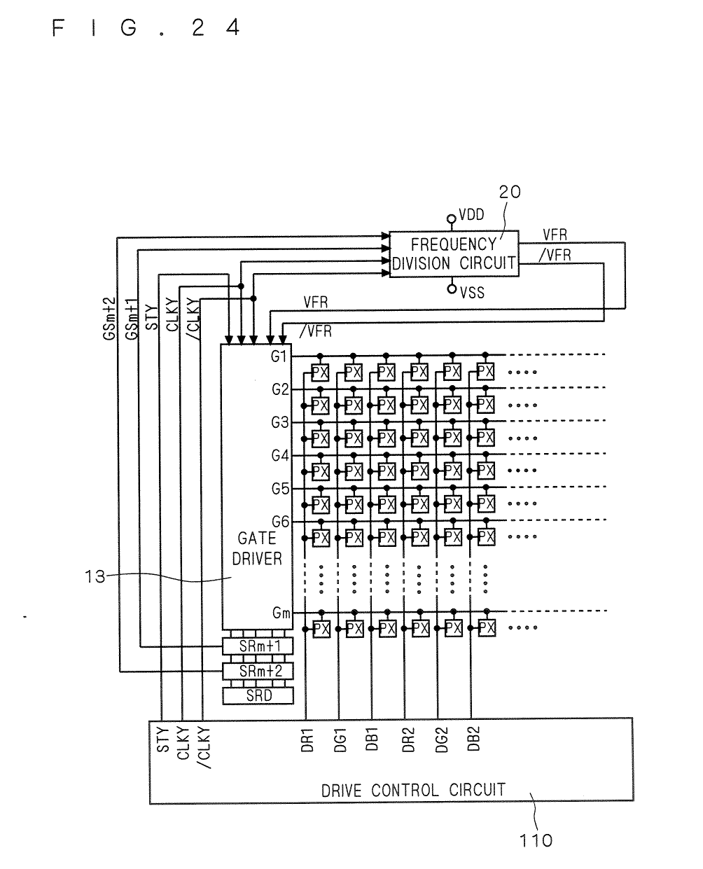

FIG. 24 is a block diagram roughly illustrating a structure of a display device according to an eighth preferred embodiment. The display device according to the eighth preferred embodiment includes m gate lines G1, G2, . . . Gm, all of which are driven by a single gate driver 13, in the same manner as in the sixth preferred embodiment (FIG. 20). However, the display device according to the eighth preferred embodiment is different from that according to the sixth preferred embodiment in that two more stages of unit shift registers SRm+1 and SRm+2 are provided to succeed the last stage (the m-th stage) of the unit shift registers for driving the m gate lines. Though signals supplied from the unit shift registers SRm+1 and SRm+2 are not used for driving a gate line, the signals supplied from the unit shift registers SRm+1 and SRm+2 will be referred to as a “drive signal GSm+1” and a “drive signal GSm+2”, respectively, for convenience of explanation. Further, a dummy unit shift register SRD for resetting the unit shift register SRm+2 is provided at a stage succeeding to the unit shift register SRm+2.

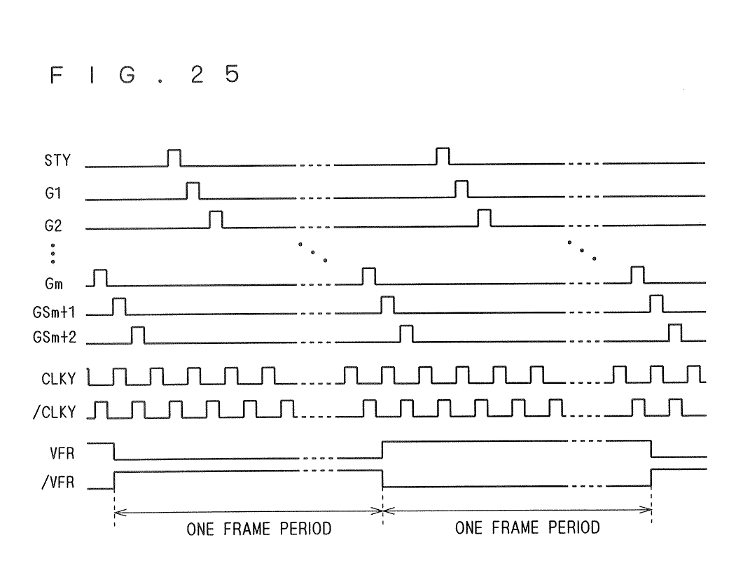

According to the eighth preferred embodiment, the frequency division circuit 20 is driven by using the drive signal GSm+1 and the drive signal GSm+2. More specifically, as compared to the sixth preferred embodiment, the start signal STY input to the frequency division circuit 20 is replaced with the drive signal GSm+2. The drive signal GSm+1 and the drive signal GSm+2 have the same period of one frame period and are out of phase with each other. Accordingly, also in the eighth preferred embodiment, the frequency division circuit 20 can generate the frequency division signals VFR and /VFR whose period is equal to one frame period, based on the theory described above with reference to FIG. 5. Operations of the frequency division circuit 20 for generating the frequency division signals VFR and /VFR according to the eighth preferred embodiment are shown by waveforms in FIG. 25. Each of the frequency division signals VFR and /VFR output from the frequency division circuit 20 is inverted each time the drive signal GSm+1 is activated.

In the structure illustrated in FIG. 24, in a case where the circuit in FIG. 7 is employed as the frequency division circuit 20, for example, the drive signal GSm+2 is input to the gate of the transistor Q1 and the drive signal GSm+1 is input to the gate of the transistor Q9. The drive signal GSm+2 is activated next to the drive signal GSm+1. In other words, a time interval of one frame period is left between a time at which the drive signal GSm+2 is once activated and a time at which the drive signal GSm+1 is activated after the activation of the drive signal GSm+2. Accordingly, the problem of malfunction due to an increase in power consumption and current leakage which has been described at the beginning of the seventh preferred embodiment may be caused. Thus, it is desirable to employ the frequency division circuit 20d according to the seventh preferred embodiment (FIG. 22) in the eighth preferred embodiment.

In the eighth preferred embodiment, however, the drive signal GSm+1 and the drive signal GSm+2 can be interchanged with each other to be input to the frequency division circuit 20. More specifically, the drive signal GSm+1 and the drive signal GSm+2 may be input to the gates of the transistors Q1 and Q9, respectively, in the frequency division circuit 20 in FIG. 7, for example. In a case where the drive signal GSm+1 and the drive signal GSm+2 are interchanged with each other as described above, the transistor Q9 is turned on immediately after the transistor Q1 is turned on, so that the above-described problem is not caused. Accordingly, any of the frequency division circuits illustrated in FIGS. 7, 12, 14, 15, and 22 can be employed without any problem.

Also, according to the eighth preferred embodiment, output signals of predetermined two out of the unit shift registers for driving the gate lines may be also used for driving the frequency division circuit 20, in place of a pair of the drive signal GSm+1 and the drive signal GSm+2. This produces an advantage of eliminating a need of additionally providing the unit shift registers SRm+1 and SRm+2. On the other hand, however, it is necessary to keep it in mind that the multipurpose use of the predetermined unit shift registers may cause a disadvantage of increasing a load on each of the predetermined unit shift registers for driving the frequency division circuit 20, to reduce a driving speed of each of gate lines which are driven by the predetermined unit shift registers.

While the invention has been shown and described in detail, the foregoing description is in all aspects illustrative and not restrictive. It is therefore understood that numerous modifications and variations can be devised without departing from the scope of the invention.

What is claimed is:

1. A display device comprising;
an insulating substrate;
a plurality of pixels arranged on said insulating substrate;
a gate driver for driving said plurality of pixels;
a drive control circuit for outputting a predetermined control signal to said gate driver; and
a frequency division circuit for dividing a frequency of a signal, wherein
said plurality of pixels, said gate driver, and said frequency division circuit are formed using thin film transistors (TFTs) formed on said insulating substrate,
said control signal output from said drive control circuit includes a start signal for a start of a frame period of an image signal, and
said frequency division circuit generates a frequency division signal whose period corresponds to a frequency which is obtained by dividing a frequency of said start signal.

2. The display device according to claim 1, wherein
all of said TFTs used for forming said plurality of pixels, said gate driver, and said frequency division circuit are of the same conductivity type.

3. The display device according to claim 1, wherein
said start signal includes first and second start signals which have the same period and are out of phase with each other,
said frequency division circuit includes first, second, and third inverters,
said first inverter receives an output of said third inverter and inverts said output of said third inverter in synchronization with said first start signal,
said second inverter receives an output of said first inverter and inverts said output of said first inverter in synchronization with said second start signal, and
said third inverter receives an output of said second inverter and inverts said output of said second inverter.

4. The display device according to claim 3, wherein
said frequency division circuit includes first and second holding circuits for allowing said first and second inverters to maintain respective levels of said outputs thereof.

5. The display device according to claim 4, wherein
said control signal output from said drive control circuit includes a clock signal having a period which is shorter than said frame period of said image signal,
said first and second holding circuits serve as first and second latch circuits which allow said first and second inverters to maintain respective levels of inputs thereof, to thereby allow said first and second inverters to maintain said respective levels of said outputs thereof, respectively,
at least one of said first and second latch circuits includes a first TFT which is connected between an input node of said at least one of said first and second inverters and a high level power supply, said first TFT serving as a load, and
said frequency division circuit further includes a first capacitive element which includes one end connected to a gate of said first TFT and the other end to which said clock signal is input.

6. The display device according to claim 5, wherein
said frequency division circuit further includes a first clamping element for controlling a potential of said gate of said first TFT such that said potential of said gate of said first TFT does not exceed a predetermined value.

7. The display device according to claim 6, wherein
said first clamping element is a TFT which is diode-connected and is connected between said gate of said first TFT and said high level power supply.

8. The display device according to claim 3, wherein
said control signal output from said drive control circuit includes a clock signal having a period which is shorter than said frame period of said image signal, and
said frequency division circuit further includes a second capacitive element which includes one end connected to an output node of one of said first, second, and third inverters and the other end to which said clock signal is input.

9. The display device according to claim 8, wherein
said frequency division circuit further includes a second clamping element for controlling a potential of said one end of said second capacitive element such that said potential of said one end of said second capacitive element does not exceed a predetermined value.

10. The display device according to claim 9, wherein
said second clamping element is a TFT which is diode-connected and is connected between said one end of said second capacitive element and said high level power supply.

11. The display device according to claim 1, wherein
said gate driver includes a plurality of shift registers which are cascaded,
said frequency division circuit includes first, second, third inverters,
said first inverter receives an output of said third inverter and inverts said output of said third inverter in synchronization with said start signal,
said second inverter receives an output of said first inverter and inverts said output of said first inverter in synchronization with an output signal of a predetermined shift register out of said plurality of shift registers, and
said third inverter receives an output of said second inverter and inverts said output of said second inverter.

12. The display device according to claim 11, wherein
said predetermined shift register out of said plurality of shift registers is not used for driving said plurality of pixels.

13. The display device according to claim 1 1, wherein
said frequency division circuit includes first and second holding circuits for allowing said first and second inverters to maintain respective levels of said outputs thereof.

14. The display device according to claim 13, wherein
said control signal output from said drive control circuit includes a clock signal having a period which is shorter than said frame period of said image signal,
said first and second holding circuits serve as first and second latch circuits which allow said first and second inverters to maintain respective levels of inputs thereof, to thereby allow said first and second inverters to maintain said respective levels of said outputs thereof, respectively,
at least one of said first and second latch circuits includes a first TFT which is connected between an input node of said at least one of said first and second inverters and a high level power supply, said first TFT serving as a load, and
said frequency division circuit further includes a first capacitive element which includes one end connected to a gate of said first TFT and the other end to which said clock signal is input.

15. The display device according to claim 14, wherein
said frequency division circuit further includes a first clamping element for controlling a potential of said gate of said first TFT such that said potential of said gate of said first TFT does not exceed a predetermined value.

16. The display device according to claim 15, wherein
said first clamping element is a TFT which is diode-connected and is connected between said gate of said first TFT and said high level power supply.

17. The display device according to claim 1 1, wherein
said control signal output from said drive control circuit includes a clock signal having a period which is shorter than said frame period of said image signal, and
said frequency division circuit further includes a second capacitive element which includes one end connected to an output node of one of said first, second, and third inverters and the other end to which said clock signal is input.

18. The display device according to claim 17, wherein
said frequency division circuit further includes a second clamping element for controlling a potential of said one end of said second capacitive element such that said potential of said one end of said second capacitive element does not exceed a predetermined value.

19. The display device according to claim 18, wherein
said second clamping element is a TFT which is diode-connected and is connected between said one end of said second capacitive element and said high level power supply.

20. The display device according to claim 1, wherein
said gate driver includes a plurality of shift registers which are cascaded,
said frequency division circuit includes first, second, and third inverters,
said first inverter receives an output of said third inverter and inverts said output of said third inverter in synchronization with an output signal of a first shift register out of said plurality of shift registers,
said second inverter receives an output of said first inverter and inverts said output of said first inverter in synchronization with an output signal of a second shift register out of said plurality of shift registers, and
said third inverter receives an output of said second inverter and inverts said output of said second inverter.

21. The display device according to claim 20, wherein
each of said first and second shift registers out of said plurality of unit shift registers is not used for driving said plurality of pixels.

22. The display device according to claim 20, wherein
said frequency division circuit includes first and second holding circuits for allowing said first and second inverters to maintain respective levels of said outputs thereof.

23. The display device according to claim 22, wherein
said control signal output from said drive control circuit includes a clock signal having a period which is shorter than said frame period of said image signal,
said first and second holding circuits serve as first and second latch circuits which allow said first and second inverters to maintain respective levels of inputs thereof, to thereby allow said first and second inverters to maintain said respective levels of said outputs thereof, respectively,
at least one of said first and second latch circuits includes a first TFT which is connected between an input node of said at least one of said first and second inverters and a high level power supply, said first TFT serving as a load, and
said frequency division circuit further includes a first capacitive element which includes one end connected to a gate of said first TFT and the other end to which said clock signal is input.

24. The display device according to claim 23, wherein
said frequency division circuit further includes a first clamping element for controlling a potential of said gate of said first TFT such that said potential of said gate of said first TFT does not exceed a predetermined value.

25. The display device according to claim 24, wherein
said first clamping element is a TFT which is diode-connected and is connected between said gate of said first TFT and said high level power supply.

26. The display device according to claim 20, wherein
said control signal output from said drive control circuit includes a clock signal having a period which is shorter than said frame period of said image signal, and
said frequency division circuit further includes a second capacitive element which includes one end connected to an output node of one of said first, second, and third inverters and the other end to which said clock signal is input.

27. The display device according to claim 26, wherein
said frequency division circuit further includes a second clamping element for controlling a potential of said one end of said second capacitive element such that said potential of said one end of said second capacitive element does not exceed a predetermined value.

28. The display device according to claim 27, wherein
said second clamping element is a TFT which is diode-connected and is connected between said one end of said second capacitive element and said high level power supply.

29. The display device according to claim 1, wherein
said frequency division circuit is configured such that respective levels of gates of all TFTs included in said frequency division circuit are inverted each time a level of said frequency division signal is inverted.

30. The display device according to claim 1, wherein
said control signal output from said drive control circuit includes a clock signal having a period which is shorter than said frame period of said image signal, and
said frequency division circuit further includes a second TFT which is connected between an output node for said frequency division signal and a high level power supply, and a third capacitive element which includes one end connected to a gate of said second TFT and the other end to which said clock signal is input.

31. The display device according to claim 30, wherein
said frequency division circuit further includes a third clamping element for controlling a potential of said gate of said second TFT such that said potential of said gate of said second TFT does not exceed a predetermined value.

32. The display device according to claim 31, wherein
said third clamping element is a TFT which is diode-connected and is connected between said gate of said second TFT and said high level power supply.

33. The display device according to claim 1, wherein
said control signal output from said drive control circuit includes a clock signal having a period which is shorter than said frame period of said image signal, and
said frequency division circuit further includes a resistance element which is connected between an output node for said frequency division signal and a high level power supply.

34. The display device according to claim 1, wherein
said gate driver includes third and fourth TFTs which are connected in parallel with each other between an output terminal of said gate driver and a low level power supply, and
said third and fourth TFTs become inoperative by turns based on said frequency division signal output from said frequency division circuit.

35. The display device according to claim 1, wherein
a display element forming said plurality of pixels is a liquid crystal element.

36. The display device according to claim 1, wherein
a display element forming said plurality of pixels is an electroluminescent element.
